(19) United States
(12) Patent Application Publication
(10) Pub. No.: US 2026/0032517 A1
(43) Pub. Date: Jan. 29, 2026

(54) TASK-BASED COMMUNICATION METHOD AND COMMUNICATION APPARATUS

(71) Applicant: HUAWEI TECHNOLOGIES CO., LTD., Shenzhen (CN)

(72) Inventors: Huanhuan Huang, Shanghai (CN); Chenghui Peng, Shanghai (CN); Weijun Xing, Shanghai (CN); Jun Wang, Shanghai (CN); Fei Wang, Shanghai (CN); Zhe Liu, Shanghai (CN)

(73) Assignee: HUAWEI TECHNOLOGIES CO., LTD., Shenzhen (CN)

(21) Appl. No.: 19/343,202

(22) Filed: Sep. 29, 2025

Related U.S. Application Data
(63) Continuation of application No. PCT/CN2023/086158, filed on Apr. 4, 2023.

(51) Int. Cl. H04W 28/16

(52) U.S. Cl. CPC H04W 28/16

(57) ABSTRACT

Embodiments of this application provide a task-based communication method and a communication apparatus. The method includes: respectively deploying task anchors TAs in a core network and an access network independently, so that a terminal device can send a task request to a first node; and the first node selects an appropriate TA based on the task request, and indicates a type of the TA to the terminal device, and the terminal device sends the task request to the TA based on the type of the TA; or the first node directly forwards the task request to the TA, and the TA completes TE deployment and executes a specific task. It can be learned that, the first node selects the TA, so that complexity of the terminal device can be reduced; and the terminal device senses the type of the TA.

### CROSS-REFERENCE TO RELATED APPLICATIONS

This application is a continuation of International Application No. PCT/CN2023/086158, filed on Apr. 4, 2023, the disclosure of which is hereby incorporated by reference in its entirety.

### TECHNICAL FIELD

Embodiments of this application relate to the communication field, and more specifically, to a task-based communication method and a communication apparatus.

### BACKGROUND

An existing radio access network (RAN) architecture, for example, a 5th generation (5G) RAN architecture, is a flattened architecture based on session management and control, where a system is used to establish a channel and allocate a corresponding connection and an air interface resource for data transmission of a user.

In addition to a conventional connection service, a future wireless communication network is to further provide a plurality of new service capabilities such as computing, AI (artificial intelligence), sensing, and data processing. To support the plurality of new service capabilities, a network needs to collaboratively schedule various heterogeneous resources such as computing, algorithm, connection, and data resources, to complete a specific service objective. This process may be considered as management and control at a task granularity, with support for a task quality of service (QOS) assurance mechanism.

A conventional wireless communication system is session-centric, performs management and control at a session granularity, and implements session QoS assurance, but cannot support task-based management and control.

### SUMMARY

Embodiments of this application provide a task-based communication method and a communication apparatus, to implement task deployment and management based on a task-centric communication architecture, and meet a task request of a terminal device.

According to a first aspect, a task-based communication method is provided. The method may be performed by a first node, or may be performed by a chip or a circuit configured in the first node. This is not limited in this application.

The method includes: receiving a first request from a terminal device, where the first request is used to request to control execution of a first task, and the first request includes information about the first task; determining a second node based on the first request, where the second node is configured to control execution of the first task; and sending a type of the second node to the terminal device, where the type of the second node includes an access network element or a core network element; or sending the first request to the second node.

The first task includes a process of implementing a service objective based on collaboration of heterogeneous resources.

The heterogeneous resources may be understood as resources such as computing, intelligence, data, and sensing resources.

The service objective may be new services such as computing, data processing, trustworthiness, intelligence, and sensing services.

The first node may be a control plane function, and the first node is configured to provide a management and control function for the first task.

For example, the first node may be responsible for managing a life cycle of the first task, completing task deployment, starting, deletion, modification, monitoring, and the like based on a requirement of the first task, and regulating a network resource to ensure task QoS.

In this application, the management and control function of the first task, for example, a cluster control node (cNode) in an access network, and a task control function (TCF) in a core network, may be deployed in the access network and the core network.

It should be understood that, in this application, an example in which a collaborative management and control function of a task in the core network is the TCF is used for description, and the task control function in the core network may alternatively evolve to another name. This is not limited in embodiments of this application.

It may be understood that the first node in this application may be the cNode in the access network, or may be the TCF in the core network.

The second node in this application is a node that is determined by the first node and that provides a collaborative management function for the first task, that is, a task anchor (TA), and is configured to deploy a TE to perform data exchange in service logic and execute a specific task. The second node and the first node may be a same node, or may be different nodes.

In this technical solution, TAs are respectively deployed in the core network and the access network independently; the terminal device may send a task request to the first node; and the first node selects an appropriate TA based on the task request, and indicates a type of the TA to the terminal device, and the terminal device sends the task request to the TA based on the type of the TA; or the first node directly forwards the task request to the TA, and the TA completes TE deployment and executes a specific task. The first node selects the TA, so that complexity of the terminal device can be reduced; and the terminal device senses the type of the TA, so that efficiency of subsequently sending a task message by the terminal device can be improved.

With reference to the first aspect, in an implementation of the first aspect, before the first request is sent to the second node, the first request received from the terminal device is sent based on the type of the second node, the type of the second node is determined by the terminal device based on a first mapping relationship, and the first mapping relationship indicates a correspondence between an event of the first task and the type of the second node.

The event of the first task includes the first task or a type of the first task.

In this technical solution, the terminal device may determine, based on a preconfigured mapping relationship, a TA type corresponding to the first task, and send the first request to the first node of the same type based on the task type, so that the first node selects a TA of the same type as the second node, and sends the first request to the second node. The terminal device may autonomously determine, based on a preconfigured mapping relationship between a task type and a TA type, a TA type corresponding to a to-be-initiated task, to directly send a task request to a TA of the type, thereby improving task access efficiency.

With reference to the first aspect, in an implementation of the first aspect, the first node sends the first mapping relationship to the terminal device.

The first mapping relationship may be in a form of a mapping relationship table, or may be in another form. This is not limited in embodiments of this application.

In this technical solution, the terminal device may obtain the first mapping relationship via the first node. For example, in a registration procedure of the terminal device, a network device may configure the first mapping relationship for the terminal device in a manner like initial registration, mobile registration update, or periodic registration update, or may configure the first mapping relationship for the terminal device in a configuration update procedure of the terminal device, or may configure the first mapping relationship in a paging procedure. This is not limited in embodiments of this application.

With reference to the first aspect, in an implementation of the first aspect, the first request further includes first configuration information, and the first configuration information includes a computing power configuration and/or an algorithm configuration for executing the first task.

In this technical solution, when the terminal device sends the first request to the first node for the first time, the request message may carry the first configuration information, and when receiving the first request, the second node may directly deploy the first task based on the first configuration information. This reduces signaling and improves task efficiency.

With reference to the first aspect, in an implementation of the first aspect, first configuration information from the terminal device is received; and the first configuration information is sent to the second node, where the first configuration information includes a computing power configuration and/or an algorithm configuration for executing the first task.

In this technical solution, after receiving a task acknowledgment message of the second node, the terminal device sends the first configuration information to the second node via the first node.

With reference to the first aspect, in an implementation of the first aspect, the first node is a core network element or an access network element.

In this technical solution, the first node may be a TA, for example, a cNode, in an access network; or may be a TA, for example, a TCF, in the core network.

With reference to the first aspect, in an implementation of the first aspect, when the first node is the core network element, the first request is received by using non-access stratum signaling; or when the first node is the access network element, the first request is received by using radio resource control signaling.

In this technical solution, the terminal device sends the first request to a TA in the core network element by using the non-access stratum signaling, and the terminal device sends the first request to a TA in the access network element by using the radio resource control signaling.

With reference to the first aspect, in an implementation of the first aspect, when the first node is the core network element, an identifier of the second node is sent to a third node, where the third node is an access network element accessed by the terminal device.

In this technical solution, when the first node is the core network element, the first node sends the type of the second node to the terminal device, and may further send the identifier of the second node to the third node. When receiving the first request sent by the first node, the third node determines, based on the identifier of the second node, to send the first request to the second node.

It may be understood that if the third node and the second node are a same node, the identifier of the second node does not need to be sent to the third node.

With reference to the first aspect, in an implementation of the first aspect, the first node may request secondary authentication from a task authentication and authorization function based on the information about the first task, where the request message includes the information about the first task; and receive a response message from the authentication and authorization function, to determine that authentication and authorization on the first task are completed.

In this technical solution, the first node determines, based on the information about the first task, that the first task is not of an existing task type, and therefore secondary authentication and authentication needs to be performed.

With reference to the first aspect, in an implementation of the first aspect, when the first node is the core network element, the first node may send first registration information to a mobility management function, where the first registration information is used to register a binding relationship between the first task and the second node with the mobility management function, and the first registration information includes an identifier of the terminal device, an identifier of the first task, and the identifier of the second node.

In this technical solution, after determining the correspondence between the first task and the second node, the first node registers a context of the first task with the mobility management function. When the terminal device moves to a new TA region after location moving, the mobility management function may trigger a TA to perform handover.

With reference to the first aspect, in an implementation of the first aspect, the information about the first task includes one or more of an identifier of the first task, an identifier of the terminal device, a type of the first task, a description of the first task, and a requirement of the first task.

According to a second aspect, a task-based communication method is provided. The method may be performed by a terminal device, or may be performed by a chip or a circuit configured in the terminal device. This is not limited in this application.

The method includes: obtaining a first node, where the first node is configured to provide a management and control function for a first task, and the first task includes a process of implementing a service objective based on collaboration of heterogeneous resources; and sending a first request to the first node, where the first request is used to request to control execution of the first task, and the first request includes information about the first task.

The heterogeneous resources may be understood as resources such as computing, intelligence, data, and sensing resources.

The service objective may be new service capabilities such as computing, data processing, trustworthiness, intelligence, and sensing.

The first node may be a control plane function, and the first node is configured to provide the management and control function for the first task.

For example, the first node may be responsible for managing a life cycle of the first task, completing task deployment, starting, deletion, modification, monitoring, and the like based on a requirement of the first task, and regulating a network resource to ensure task QoS.

In this application, the management and control function of the first task, for example, a cluster control node (cNode) in an access network, and a task control function (TCF) in a core network, may be deployed in the access network and the core network.

It should be understood that, in this application, an example in which a collaborative management and control function of a task in the core network is the TCF is used for description, and the task control function in the core network may alternatively evolve to another name. This is not limited in embodiments of this application.

It may be understood that the first node in this application may be the cNode in the access network, or may be the TCF in the core network.

In this technical solution, the terminal device may obtain the first node, and then send the first request to the first node, so that the first node selects an appropriate TA to perform task deployment.

With reference to the second aspect, in an implementation of the second aspect, a type of a second node is determined based on a first mapping relationship, where the first mapping relationship indicates a correspondence between an event of the first task and the type of the second node, and the type of the second node includes a core network element or an access network element; and the first node is determined based on the type of the second node, where a type of the first node is the same as the type of the second node.

In this application, the event of the first task includes the first task or a type of the first task.

In this technical solution, the terminal device may determine, based on a preconfigured mapping relationship, a TA type corresponding to the first task, and send the first request to the first node of the same type based on the task type, so that the first node selects a TA of the same type as the second node, and sends the first request to the second node. The terminal device may autonomously determine, based on a preconfigured mapping relationship between a task type and a TA type, a TA type corresponding to a to-be-initiated task, to directly send a task request to a TA of the type, thereby improving task access efficiency.

With reference to the second aspect, in an implementation of the second aspect, the first mapping relationship from an access network element or a core network element is received.

In this technical solution, the terminal device may obtain the first mapping relationship via an access network device or a core network device. This is the same as the specific solution in the first aspect, and details are not described again.

With reference to the second aspect, in an implementation of the second aspect, a type of a second node is received from the first node, where the type of the second node includes a core network element or an access network element, and the second node is a node that is determined by the first node and that is configured to control execution of the first task; and the first request is sent to the second node based on the type of the second node, where the first request is used to request to control execution of the first task.

In this technical solution, the terminal device receives the type of the second node from the first node, and initiates a task request to the second node based on the type of the second node. The terminal device may sense a type of a TA, so that efficiency of subsequently sending a task message by the terminal device can be improved.

With reference to the second aspect, in an implementation of the second aspect, the first request further includes first configuration information, and the first configuration information includes a computing power configuration and/or an algorithm configuration for executing the first task.

Beneficial effects of the technical solution are the same as those in the first aspect, and details are not described again.

With reference to the second aspect, in an implementation of the second aspect, first configuration information is sent to the second node based on the type of the second node, where the first configuration information includes a computing power configuration and/or an algorithm configuration for executing the first task.

Beneficial effects of the technical solution are the same as those in the first aspect, and details are not described again.

With reference to the second aspect, in an implementation of the second aspect, the first node is a core network element or an access network element.

With reference to the second aspect, in an implementation of the second aspect, when the first node is the core network element, the first request is sent by using non-access stratum signaling; or when the first node is the access network element, the first request is sent by using radio resource control signaling.

With reference to the second aspect, in an implementation of the second aspect, the information about the first task includes one or more of an identifier of the first task, an identifier of the terminal device, a type of the first task, a description of the first task, and a requirement of the first task.

According to a third aspect, a task-based communication method is provided. The method may be performed by a third node, or may be performed by a chip or a circuit configured in the third node. This is not limited in this application.

The method includes: receiving a first request from a terminal device, where the first request is used to request to control execution of a first task, the first request includes information about the first task requested by the terminal device, and the first task includes a process of implementing a service objective based on collaboration of heterogeneous resources; determining a second node based on an identifier that is of the second node and that is sent by a first node, where the first node is configured to provide a management and control function for the first task; and sending the first request to the second node; or controlling execution of the first task based on the first request.

The first task includes the process of implementing the service objective based on the collaboration of the heterogeneous resources.

The heterogeneous resources may be understood as resources such as computing, intelligence, data, and sensing resources.

The service objective may be new service capabilities such as computing, data processing, trustworthiness, intelligence, and sensing.

The first node may be a control plane function, and the first node is configured to provide the management and control function for the first task.

For example, the first node may be responsible for managing a life cycle of the first task, completing task deployment, starting, deletion, modification, monitoring, and the like based on a requirement of the first task, and regulating a network resource to ensure task QoS.

In this application, the management and control function of the first task, for example, a cluster control node (cNode) in an access network, and a task control function (TCF) in a core network, may be deployed in the access network and the core network.

It should be understood that, in this application, an example in which a task control function in the core network is the TCF is used for description, and the task control function in the core network may alternatively evolve to another name. This is not limited in embodiments of this application.

It may be understood that the first node in this application may be the cNode in the access network, or may be the TCF in the core network.

The second node in this application is a node that is determined by the first node and that provides a collaborative management function for the first task, that is, a TA, and is configured to deploy a TE to perform data exchange in service logic and execute a specific task. The second node and the first node may be a same node, or may be different nodes.

The third node in this application is a TA of the access network, for example, may be a cNode.

In this technical solution, the third node receives the first request from the terminal device, and sends the first request to the second node based on the identifier of the second node, or controls execution of the first task based on the first request.

With reference to the third aspect, in an implementation of the third aspect, the first request further includes first configuration information, and the first configuration information includes a computing power configuration and/or an algorithm configuration for executing the first task.

Beneficial effects of the technical solution are the same as those in the first aspect, and details are not described again.

With reference to the third aspect, in an implementation of the third aspect, first configuration information from the terminal device is received; and the first configuration information is sent to the second node, where the first configuration information includes a computing power configuration and/or an algorithm configuration for executing the first task.

Beneficial effects of the technical solution are the same as those in the first aspect, and details are not described again.

With reference to the third aspect, in an implementation of the third aspect, the first node is a core network element or an access network element.

Beneficial effects of the technical solution are the same as those in the first aspect, and details are not described again.

With reference to the third aspect, in an implementation of the third aspect, the information about the first task includes one or more of an identifier of the first task, an identifier of the terminal device, a type of the first task, a description of the first task, and a requirement of the first task.

According to a fourth aspect, a task-based communication method is provided. The method may be performed by a terminal device, or may be performed by a chip or a circuit configured in the terminal device. This is not limited in this application.

The method includes: determining a type of a second node based on a first mapping relationship, where the first mapping relationship indicates a correspondence between an event of a first task and the type of the second node, the second node is a node configured to control execution of the first task, and the type of the second node includes a core network element or an access network element; and sending a first request to the second node based on the type of the second node, where the first request is used to request to control execution of the first task, and the first request includes information about the first task.

The task event of the first task includes the first task or a type of the first task.

In this technical solution, the terminal device determines, based on the first mapping relationship, the type of the second node corresponding to the first task, where a node of the type may be considered as the second node; and sends the first request to the second node, to request to control execution of the first task. In other words, the terminal device may autonomously determine, based on a preconfigured mapping relationship between a task type and a TA type, a TA type corresponding to a to-be-initiated task, to directly send a task request to a TA of the type, thereby improving task access efficiency.

With reference to the fourth aspect, in an implementation of the fourth aspect, the first request further includes first configuration information, and the first configuration information includes a computing power configuration and/or an algorithm configuration for executing the first task.

With reference to the fourth aspect, in an implementation of the fourth aspect, first configuration information is sent to the second node based on the type of the second node, where the first configuration information includes a computing power configuration and/or an algorithm configuration for executing the first task.

With reference to the fourth aspect, in an implementation of the fourth aspect, the information about the first task includes one or more of an identifier of the first task, an identifier of the terminal device, a type of the first task, a description of the first task, and a requirement of the first task.

With reference to the fourth aspect, in an implementation of the fourth aspect, the first mapping relationship from the first node is received.

According to a fifth aspect, a task-based communication method is provided. The method may be performed by a second node, or may be performed by a chip or a circuit configured in the second node. This is not limited in this application.

The method includes: receiving a first request from a terminal device, where the first request is used to request to control execution of a first task, the first request includes information about the first task, and the first task includes a process of implementing a service objective based on collaboration of heterogeneous resources; and controlling execution of the first task based on the first request.

The second node may be a node that is determined by the first node and that provides a collaborative management function for the first task, that is, a task anchor (TA), and is configured to deploy a TE to perform data exchange in service logic and execute a specific task. The second node and the first node may be a same node, or may be different nodes.

It may be understood that the first node in this application may be a cNode in an access network, or may be a TCF in a core network.

In this technical solution, the second node receives the first request from the terminal device, and controls execution of the first task based on the first request.

With reference to the fifth aspect, in an implementation of the fifth aspect, a second request is sent to a task authentication and authorization function based on the information about the first task, where the second request includes the information about the first task; and a first response message is received from the task authentication and authorization function, where the first response message is used to determine that authentication and authentication on the first task are completed.

Beneficial effects of the technical solution are the same as those in the first aspect, and details are not described again.

With reference to the fifth aspect, in an implementation of the fifth aspect, the first request further includes first configuration information, and the first configuration information includes a computing power configuration and/or an algorithm configuration for executing the first task. Execution of the first task is controlled based on the first configuration information.

Beneficial effects of the technical solution are the same as those in the first aspect, and details are not described again.

With reference to the fifth aspect, in an implementation of the fifth aspect, first configuration information is received from the terminal device, where the first configuration information includes a computing power configuration and/or an algorithm configuration for executing the first task; and execution of the first task is controlled based on the first configuration information.

Beneficial effects of the technical solution are the same as those in the first aspect, and details are not described again.

With reference to the fifth aspect, in an implementation of the fifth aspect, the information about the first task includes one or more of an identifier of the first task, an identifier of the terminal device, a type of the first task, a description of the first task, and a requirement of the first task.

Beneficial effects of the technical solution are the same as those in the first aspect, and details are not described again.

With reference to the fifth aspect, in an implementation of the fifth aspect, when the second node is a core network element, the method further includes: sending first registration information to a mobility management function, where the first registration information is used to register a binding relationship between the first task and the second node with the mobility management function, and the first registration information includes the identifier of the terminal device, the identifier of the first task, and an identifier of the second node.

Beneficial effects of the technical solution are the same as those in the first aspect, and details are not described again.

According to a sixth aspect, a communication apparatus is provided. The apparatus may be a first node, or may be a chip or a circuit configured in the first node. This is not limited in this application.

The apparatus includes: a transceiver unit, configured to receive a first request from a terminal device, where the first request is used to request to control execution of a first task, and the first request includes information about the first task; and a processing unit, configured to determine a second node based on the first request, where the second node is configured to control execution of the first task, where the transceiver unit is further configured to send a type of the second node to the terminal device, where the type of the second node includes an access network element or a core network element; or send the first request to the second node.

The first task includes a process of implementing a service objective based on collaboration of heterogeneous resources.

The heterogeneous resources may be understood as resources such as computing, intelligence, data, and sensing resources.

The service objective may be new service capabilities such as computing, data processing, trustworthiness, intelligence, and sensing.

The first node may be a control plane function, and the first node is configured to provide a management and control function for the first task.

For example, the first node may be responsible for managing a life cycle of the first task, completing task deployment, starting, deletion, modification, monitoring, and the like based on a requirement of the first task, and regulating a network resource to ensure task QoS.

In this application, the management and control function of the first task, for example, a cluster control node cNode in an access network, and a task control function TCF in a core network, may be deployed in the access network and the core network.

It should be understood that, in this application, an example in which a management and control function of a task in the core network is the TCF is used for description, and the task control function in the core network may alternatively evolve to another name. This is not limited in embodiments of this application.

It may be understood that the first node in this application may be the cNode in the access network, or may be the TCF in the core network.

The second node in this application is a node that is determined by the first node and that provides a control function for the first task, that is, a task anchor TA, and is configured to deploy a TE to perform data exchange in service logic and execute a specific task. The second node and the first node may be a same node, or may be different nodes.

In this technical solution, TAs are respectively deployed in the core network and the access network independently; the terminal device may send a task request to the first node; and the first node selects an appropriate TA based on the task request, and indicates a type of the TA to the terminal device, and the terminal device sends the task request to the TA based on the type of the TA; or the first node directly forwards the task request to the TA, and the TA completes TE deployment and executes a specific task. The first node selects the TA, so that complexity of the terminal device can be reduced; and the terminal device senses the type of the TA, so that efficiency of subsequently sending a task message by the terminal device can be improved.

With reference to the sixth aspect, in an implementation of the sixth aspect, before the transceiver unit sends the first request to the second node, the first request received by the transceiver unit is sent based on the type of the second node, the type of the second node is determined by the terminal device based on a first mapping relationship, and the first mapping relationship indicates a correspondence between an event of the first task and the type of the second node.

In this technical solution, the terminal device may determine, based on a preconfigured mapping relationship, a TA type corresponding to the first task, and send the first request to the first node of the same type based on the task type, so that the first node selects a TA of the same type as the second node, and sends the first request to the second node. The terminal device may autonomously determine, based on a preconfigured mapping relationship between a task type and a TA type, a TA type corresponding to a to-be-initiated task, to directly send a task request to a TA of the type, thereby improving task access efficiency.

With reference to the sixth aspect, in an implementation of the sixth aspect, the transceiver unit is further configured to send the first mapping relationship to the terminal device.

The first mapping relationship may be in a form of a mapping relationship table, or may be in another form. This is not limited in embodiments of this application.

In this technical solution, the terminal device may obtain the first mapping relationship via the first node. For example, in a registration procedure of the terminal device, a network device may configure the first mapping relationship for the terminal device in a manner like initial registration, mobile registration update, or periodic registration update, or may configure the first mapping relationship for the terminal device in a configuration update procedure of the terminal device, or may configure the first mapping relationship in a paging procedure. This is not limited in embodiments of this application.

With reference to the sixth aspect, in an implementation of the sixth aspect, the first request further includes first configuration information, and the first configuration information includes a computing power configuration and/or an algorithm configuration for executing the first task.

In this technical solution, when the terminal device sends the first request to the first node for the first time, the request message may carry the first configuration information, and when receiving the first request, the second node may directly deploy the first task based on the first configuration information. This reduces signaling and improves task efficiency.

With reference to the sixth aspect, in an implementation of the sixth aspect, the transceiver unit is further configured to receive the first configuration information from the terminal device; and the transceiver unit is further configured to send the first configuration information to the second node, where the first configuration information includes the computing power configuration and/or the algorithm configuration for executing the first task.

In this technical solution, after receiving a task acknowledgment message of the second node, the terminal device sends the first configuration information to the second node via the first node.

With reference to the sixth aspect, in an implementation of the sixth aspect, the first node is a core network element or an access network element.

In this technical solution, the first node may be a TA, for example, a cNode, in an access network; or may be a TA, for example, a TCF, in the core network.

With reference to the sixth aspect, in an implementation of the sixth aspect, when the first node is the core network element, the transceiver unit is specifically configured to receive the first request by using non-access stratum signaling; or when the first node is the access network element, the transceiver unit is specifically configured to receive the first request by using radio resource control signaling.

In this technical solution, the terminal device sends the first request to a TA in the core network element by using the non-access stratum signaling, and the terminal device sends the first request to a TA in the access network element by using the radio resource control signaling.

With reference to the sixth aspect, in an implementation of the sixth aspect, when the first node is the core network element, the transceiver unit is further configured to send an identifier of the second node to a third node, where the third node is an access network element accessed by the terminal device.

In this technical solution, when the first node is the core network element, the first node sends the type of the second node to the terminal device, and may further send the identifier of the second node to the third node. When receiving the first request sent by the first node, the third node determines, based on the identifier of the second node, to send the first request to the second node.

It may be understood that if the third node and the second node are a same node, the identifier of the second node does not need to be sent to the third node.

With reference to the sixth aspect, in an implementation of the sixth aspect, the transceiver unit is further configured to request secondary authentication from a task authentication and authorization function based on the information about the first task, where the request message includes the information about the first task; and receive a response message from the authentication and authorization function, to determine that authentication and authentication on the first task are completed.

In this technical solution, the first node determines, based on the information about the first task, that the first task is not of an existing task type, and therefore secondary authentication and authentication needs to be performed.

With reference to the sixth aspect, in an implementation of the sixth aspect, when the first node is the core network element, the transceiver unit is further configured to send first registration information to a mobility management function, where the first registration information is used to register a binding relationship between the first task and the second node with the mobility management function, and the first registration information includes an identifier of the terminal device, an identifier of the first task, and the identifier of the second node.

In this technical solution, after determining a correspondence between the first task and the second node, the first node registers a context of the first task with the mobility management function. When the terminal device moves to a new TA region after location moving, the mobility management function may trigger a TA to perform handover.

With reference to the sixth aspect, in an implementation of the sixth aspect, the information about the first task includes one or more of an identifier of the first task, an identifier of the terminal device, a type of the first task, a description of the first task, and a requirement of the first task.

According to a seventh aspect, a communication apparatus is provided. The apparatus may be a terminal device, or may be a chip or a circuit configured in the terminal device. This is not limited in this application.

The apparatus includes: a processing unit, configured to obtain a first node, where the first node is configured to provide a management and control function for a first task, and the first task includes a process of implementing a service objective based on collaboration of heterogeneous resources; and a transceiver unit, configured to send a first request to the first node, where the first request is used to request to control execution of the first task, and the first request includes information about the first task.

It may be understood that the first node in this application may be a cNode in an access network, or may be a TCF in a core network.

In this technical solution, the terminal device may obtain the first node, and then send the first request to the first node, so that the first node selects an appropriate TA to perform task deployment.

With reference to the seventh aspect, in an implementation of the seventh aspect, the processing unit is specifically configured to determine a type of the second node based on a first mapping relationship, where the first mapping relationship indicates a correspondence between an event of the first task and the type of the second node, and the type of the second node includes a core network element or an access network element; and the processing unit is specifically configured to determine the first node based on the type of the second node, where a type of the first node is the same as the type of the second node.

With reference to the seventh aspect, in an implementation of the seventh aspect, the transceiver unit is further configured to receive the first mapping relationship from an access network element or a core network element.

With reference to the seventh aspect, in an implementation of the seventh aspect, the transceiver unit is further configured to receive a type of a second node from the first node, where the type of the second node includes a core network element or an access network element, and the second node is a node that is determined by the first node and that is configured to control execution of the first task; and the transceiver unit is further configured to send the first request to the second node based on the type of the second node, where the first request is used to request to control execution of the first task.

In this technical solution, the terminal device receives the type of the second node from the first node, and initiates a task request to the second node based on the type of the second node. The terminal device may sense a type of a TA, so that efficiency of subsequently sending a task message by the terminal device can be improved.

With reference to the seventh aspect, in an implementation of the seventh aspect, the first request further includes first configuration information, and the first configuration information includes a computing power configuration and/or an algorithm configuration for executing the first task.

Beneficial effects of the technical solution are the same as those in the first aspect, and details are not described again.

With reference to the seventh aspect, in an implementation of the seventh aspect, the transceiver unit is further configured to send first configuration information to the second node based on the type of the second node, where the first configuration information includes a computing power configuration and/or an algorithm configuration for executing the first task.

Beneficial effects of the technical solution are the same as those in the first aspect, and details are not described again.

With reference to the seventh aspect, in an implementation of the seventh aspect, the first node is a core network element or an access network element.

With reference to the seventh aspect, in an implementation of the seventh aspect, when the first node is the core network element, the transceiver unit is specifically configured to send the first request by using non-access stratum signaling; or when the first node is the access network element, the transceiver unit is specifically configured to send the first request by using radio resource control signaling.

With reference to the seventh aspect, in an implementation of the seventh aspect, the information about the first task includes one or more of an identifier of the first task, an identifier of the terminal device, a type of the first task, a description of the first task, and a requirement of the first task.

According to an eighth aspect, a communication apparatus is provided. The apparatus may be a third node, or may be a chip or a circuit configured in the third node. This is not limited in this application.

The apparatus includes: a transceiver unit, configured to receive a first request from a terminal device, where the first request is used to request to control execution of a first task, the first request includes information about the first task requested by the terminal device, and the first task includes a process of implementing a service objective based on collaboration of heterogeneous resources; and a processing unit, configured to determine a second node based on an identifier that is of the second node and that is sent by a first node, where the first node is configured to provide a management and control function for the first task, where the transceiver unit is further configured to send the first request to the second node; or the processing unit is configured to control execution of the first task based on the first request.

It may be understood that the first node in this application may be a cNode in an access network, or may be a TCF in a core network.

The second node in this application is a node that is determined by the first node and that provides a collaborative management function for the first task, that is, a task anchor TA, and is configured to deploy a TE to perform data exchange in service logic and execute a specific task. The second node and the first node may be a same node, or may be different nodes.

The third node in this application is a TA of the access network, for example, may be a cNode.

In this technical solution, the third node receives the first request from the terminal device, and sends the first request to the second node based on the identifier of the second node, or controls execution of the first task based on the first request.

With reference to the eighth aspect, in an implementation of the eighth aspect, the first request further includes first configuration information, and the first configuration information includes a computing power configuration and/or an algorithm configuration for executing the first task.

Beneficial effects of the technical solution are the same as those in the first aspect, and details are not described again.

With reference to the eighth aspect, in an implementation of the eighth aspect, the transceiver unit is further configured to receive the first configuration information from the terminal device; and the transceiver unit is further configured to send the first configuration information to the second node, where the first configuration information includes the computing power configuration and/or the algorithm configuration for executing the first task.

Beneficial effects of the technical solution are the same as those in the first aspect, and details are not described again.

With reference to the eighth aspect, in an implementation of the eighth aspect, the first node is a core network element or an access network element.

Beneficial effects of the technical solution are the same as those in the first aspect, and details are not described again.

With reference to the eighth aspect, in an implementation of the eighth aspect, the information about the first task includes one or more of an identifier of the first task, an identifier of the terminal device, a type of the first task, a description of the first task, and a requirement of the first task.

According to a ninth aspect, a communication apparatus is provided. The apparatus may be a terminal device, or may be a chip or a circuit configured in the terminal device. This is not limited in this application.

The apparatus includes: a processing unit, configured to determine a type of a second node based on a first mapping relationship, where the first mapping relationship indicates a correspondence between an event of a first task and the type of the second node, the second node is a node configured to control execution of the first task, and the type of the second node includes a core network element or an access network element; and a transceiver unit, configured to send a first request to the second node based on the type of the second node, where the first request information carries information about the first task, and the first request is used to request to control execution of the first task.

In this technical solution, the terminal device determines, based on the first mapping relationship, the type of the second node corresponding to the first task, and the node of the type may be considered as the second node, to send the first request to the second node, so as to request to control execution of the first task. In other words, the terminal device may autonomously determine, based on a preconfigured mapping relationship between a task type and a TA type, a TA type corresponding to a to-be-initiated task, to directly send a task request to a TA of the type, thereby improving task access efficiency.

With reference to the ninth aspect, in an implementation of the ninth aspect, the first request further includes first configuration information, and the first configuration information includes a computing power configuration and/or an algorithm configuration for executing the first task.

With reference to the ninth aspect, in an implementation of the ninth aspect, the transceiver unit is further configured to send first configuration information to the second node based on the type of the second node, where the first configuration information includes a computing power configuration and/or an algorithm configuration for executing the first task.

With reference to the ninth aspect, in an implementation of the ninth aspect, the information about the first task includes one or more of an identifier of the first task, an identifier of the terminal device, a type of the first task, a description of the first task, and a requirement of the first task.

With reference to the ninth aspect, in an implementation of the ninth aspect, the transceiver unit is further configured to receive the first mapping relationship from the first node.

According to a tenth aspect, a communication apparatus is provided. The apparatus may be a second node, or may be a chip or a circuit configured in the second node. This is not limited in this application.

The apparatus includes: a transceiver unit, configured to receive a first request from a terminal device, where the first request is used to request to control execution of a first task, the first request includes information about the first task, and the first task includes a process of implementing a service objective based on collaboration of heterogeneous resources; and a processing unit, configured to control execution of the first task based on the first request.

The second node may be a node that is determined by the first node and that provides a collaborative management function for the first task, that is, a task anchor TA, and is configured to deploy a TE to perform data exchange in service logic and execute a specific task. The second node and the first node may be a same node, or may be different nodes.

It may be understood that the first node in this application may be a cNode in an access network, or may be a TCF in a core network.

In this technical solution, the second node receives the first request from the terminal device, and controls execution of the first task based on the first request.

With reference to the tenth aspect, in an implementation of the tenth aspect, the transceiver unit is further configured to: send a second request to a task authentication and authorization function based on the information about the first task, where the second request includes the information about the first task; and receive a first response message from the task authentication and authorization function, where the first response message is used to determine that authentication and authentication on the first task are completed.

Beneficial effects of the technical solution are the same as those in the first aspect, and details are not described again.

With reference to the tenth aspect, in an implementation of the tenth aspect, the first request further includes first configuration information, and the first configuration information includes a computing power configuration and/or an algorithm configuration for executing the first task. The processing unit is further configured to control execution of the first task based on the first configuration information.

Beneficial effects of the technical solution are the same as those in the first aspect, and details are not described again.

With reference to the tenth aspect, in an implementation of the tenth aspect, the transceiver unit is further configured to receive the first configuration information from the terminal device, where the first configuration information includes the computing power configuration and/or the algorithm configuration for executing the first task; and the processing unit is further configured to control execution of the first task based on the first configuration information.

Beneficial effects of the technical solution are the same as those in the first aspect, and details are not described again.

With reference to the tenth aspect, in an implementation of the tenth aspect, the information about the first task includes one or more of an identifier of the first task, an identifier of the terminal device, a type of the first task, a description of the first task, and a requirement of the first task.

Beneficial effects of the technical solution are the same as those in the first aspect, and details are not described again.

With reference to the tenth aspect, in an implementation of the tenth aspect, when the second node is a core network element, the transceiver unit is further configured to send first registration information to a mobility management function, where the first registration information is used to register a binding relationship between the first task and the second node with the mobility management function, and the first registration information includes an identifier of the terminal device, an identifier of the first task, and an identifier of the second node.

Beneficial effects of the technical solution are the same as those in the first aspect, and details are not described again.

According to an eleventh aspect, this application provides a processor, configured to perform the method provided in the foregoing aspects.

Unless otherwise specified, or if operations, such as sending and obtaining/receiving, related to the processor do not contradict actual functions or internal logic of the operations in related descriptions, the operations may be understood as operations, such as outputting, receiving, and inputting, of the processor, or may be understood as sending and receiving operations performed by a radio frequency circuit and an antenna. This is not limited in this application.

According to a twelfth aspect, this application provides a communication apparatus. The apparatus includes: a memory, configured to store a program; and at least one processor, configured to execute a computer program or instructions stored in the memory, to perform the method provided in any one of the foregoing aspects or the implementations of the foregoing aspects.

According to a thirteenth aspect, this application provides a computer-readable storage medium. The computer-readable medium stores program code to be executed by a device, and the program code is run to perform the method provided in any one of the foregoing aspects or the implementations of the foregoing aspects.

According to a fourteenth aspect, this application provides a computer program product including instructions. When the computer program product runs on a computer, the computer is enabled to perform the method provided in any one of the foregoing aspects or the implementations of the foregoing aspects.

According to a fifteenth aspect, this application provides a chip. The chip includes a processor and a communication interface. The processor reads, through the communication interface, instructions stored in a memory, to perform the method provided in any one of the foregoing aspects or the implementations of the foregoing aspects.

Optionally, in an implementation, the chip further includes the memory. The memory stores a computer program or the instructions. The processor is configured to execute the computer program or the instructions stored in the memory. When the computer program is executed or the instructions are executed, the processor is configured to perform the method provided in any one of the foregoing aspects or the implementations of the foregoing aspects.

### BRIEF DESCRIPTION OF DRAWINGS

FIG. 1 is a diagram of a communication system architecture applicable to an embodiment of this application;

FIG. 2 is a diagram of an application architecture of a communication system applicable to an embodiment of this application;

FIG. 3 shows a protocol stack architecture applicable to an embodiment of this application;

FIG. 4 shows a protocol stack architecture applicable to an embodiment of this application;

FIG. 5 shows a protocol stack architecture applicable to an embodiment of this application;

FIG. 6 shows a protocol stack architecture applicable to an embodiment of this application;

FIG. 7 is a diagram of a task-based communication method 700 according to an embodiment of this application;

FIG. 8 is a diagram of a task-based communication method 800 according to an embodiment of this application;

FIG. 9 is a diagram of a task-based communication method 900 according to an embodiment of this application;

FIG. 10 is a diagram of a task-based communication method 1000 according to an embodiment of this application;

FIG. 11 is a diagram of a task-based communication method 1100 according to an embodiment of this application;

FIG. 12 is a diagram of a task-based communication apparatus 1200 according to an embodiment of this application; and

FIG. 13 is a diagram of a task-based communication apparatus 1300 according to an embodiment of this application.

### DESCRIPTION OF EMBODIMENTS

The following describes technical solutions of this application with reference to accompanying drawings.

The technical solutions provided in this application may be applied to various communication systems, such as a 5th generation (5G) or new radio (NR) system, a long term evolution (LTE) system, an LTE frequency division duplex (FDD) system, and an LTE time division duplex (TDD) system. The technical solutions provided in this application may be further applied to a future communication system, for example, a 6th generation mobile communication system. The technical solutions provided in this application may be further applied to device-to-device (D2D) communication, vehicle-to-everything (V2X) communication, machine-to-machine (M2M) communication, machine type communication (MTC), an internet of things (iIoT) communication system, or another communication system.

A communication system applicable to this application is first briefly described below.

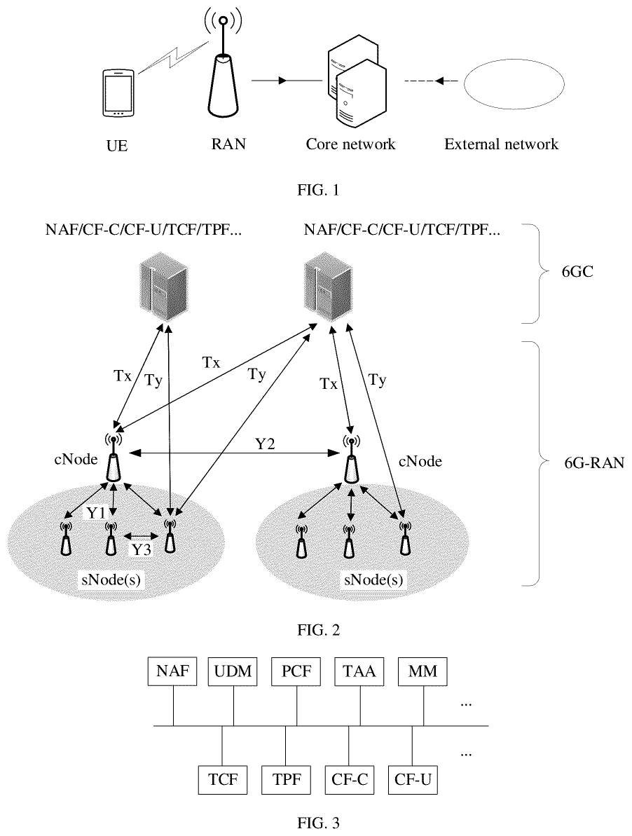

As an example, FIG. 1 is a diagram of a communication system architecture. For example, the architecture may include a RAN, a terminal, a core network (CN), an external network, and the like. The external network may be a data network (DN). The RAN is a RAN provided in this application, or is referred to as a RAN node, a RAN device, an access network device, or the like, and may include a cluster control node and a service serving node. For details, refer to the following descriptions.

A terminal device in this application may be referred to as an access terminal, a subscriber unit, a subscriber station, a mobile station, a remote station, a remote terminal, a mobile device, a user terminal, a terminal, a wireless communication device, a user agent, a user apparatus, or the like.

The terminal device may be a device that provides voice/data for a user, for example, a handheld device having a wireless connection function or a vehicle-mounted device. Currently, some examples of a terminal are: a mobile phone, a tablet computer, a notebook computer, a palmtop computer, a mobile internet device (MID), a wearable device, a virtual reality (VR) device, an augmented reality (AR) device, a wireless terminal in industrial control, a wireless terminal in self-driving, a wireless terminal in a remote medical surgery, a wireless terminal in a smart grid, a wireless terminal in transportation safety a wireless terminal in a smart city, a wireless terminal in a smart home, a cellular phone, a cordless phone, a session initiation protocol (SIP) phone, a wireless local loop (WLL) station, a personal digital assistant (PDA), a handheld device having a wireless communication function, a computing device or another processing device connected to a wireless modem, a wearable device, a terminal device in a 5G network, a terminal device in a future evolved public land mobile communication network (PLMN), or the like. This is not limited in embodiments of this application.

As an example, instead of a limitation, in embodiments of this application, the terminal device may alternatively be a wearable device. The wearable device may also be referred to as a wearable intelligent device, and is a general term of a wearable device that is intelligently designed and developed for daily wear by using a wearable technology, for example, glasses, gloves, a watch, clothing, and shoes. The wearable device is a portable device that can be directly worn on the body or integrated into clothes or an accessory of a user. The wearable device is not only a hardware device, but also implements a powerful function through software support, data exchange, and cloud interaction. Generalized wearable intelligent devices include full-featured and large-size devices that can implement complete or partial functions without depending on smartphones, such as smart watches or smart glasses, and devices that focus on only one type of application function and need to work with other devices such as smartphones, such as various smart bands or smart jewelry for monitoring physical signs.

In addition, the terminal device in embodiments of this application may alternatively be a terminal device in an IoT system. An IoT is an important part of future development of information technologies. A main technical feature of the IoT is connecting a thing to a network through a communication technology, to implement an intelligent network for human-machine interconnection and thing-thing interconnection.

It should be noted that the terminal device and an access network device may communicate with each other by using an air interface technology (for example, but not limited to an NR or an LTE technology). Terminal devices may also communicate with each other by using an air interface technology (for example, but not limited to an NR or an LTE technology).

In embodiments of this application, an apparatus configured to implement a function of the terminal device may be a terminal device; or may be an apparatus, for example, a chip system or a chip, that can support a terminal device in implementing the function, and the apparatus may be mounted in the terminal device. In embodiments of this application, the chip system may include a chip, or may include a chip and another discrete component.

The access network (AN) device in this application may provide a function of accessing a communication network for an authorized user in a specific region, and may specifically include a wireless network device in a 3rd generation partnership project (3GPP) network, or may include an access point in a non-3GPP network. For ease of description, the following uses the AN device for representation.

The AN device may use different radio access technologies. Currently, there are two types of wireless access technologies: a 3GPP access technology (for example, a wireless access technology used in a 3rd generation (3G) system, a 4th generation (4G) system, or a 5G system) and a non-3GPP access technology. The 3GPP access technology is an access technology that complies with a 3GPP standard specification. For example, an access network device in the 5G system is referred to as a next generation node base station (gNB) or a RAN device. The non-3GPP access technology may include an air interface technology represented by an access point (AP) in wireless fidelity (Wi-Fi), a worldwide interoperability for microwave access (WiMAX), code division multiple access (CDMA), and the like. The AN device may allow interconnection and interworking performed between the terminal device and a 3GPP core network by using the non-3GPP technology.

The AN device can be responsible for functions such as radio resource management, quality of service (QOS) management, data compression and encryption on an air interface side. The AN device provides an access service for the terminal device, to complete forwarding a control signal and user data between the terminal device and the core network.

For example, the AN device may include but is not limited to a macro base station, a micro base station (also referred to as a small cell), a radio network controller (RNC), a NodeB (NB), a base station controller (BSC), a base transceiver station (BTS), a home base station (for example, a home evolved NodeB, or a home NodeB, HNB), a baseband unit (BBU), an AP in a Wi-Fi system, a radio relay node, a radio backhaul node, a transmission point (TP), or a transmission and reception point (tTRP); may be a gNB or a transmission point (TRP or TP) in a 5G (for example, NR) system, or one antenna panel or a group of antenna panels (including a plurality of antenna panels) of a base station in a 5G system; or may be a network node constituting a gNB or a transmission point, for example, a distributed unit (DU), or a base station in a next generation 6G communication system. A specific technology and a specific device form that are used by the AN device are not limited in embodiments of this application.

In addition to providing a basic connection service, the RAN provided in this application further needs to provide various new service capabilities such as computing, data processing, trustworthiness, intelligence, and sensing, to effectively enable everything as a service (XaaS) in a future communication system. Therefore, the future communication system needs to provide the new service capability based on a collaboration capability of multi-dimensional heterogeneous resources (computing, AI data, AI model, and the like), and this is to drive evolution of a future radio access network (RAN) architecture.

A process of completing a specific objective based on multi-dimensional resource collaboration at a network layer is defined as a “task”. In other words, a task is a process of completing a specific objective by collaborating heterogeneous resources such as computing, algorithm, connection, and data resources.

It should be noted that the “task” defined in this application is different from a connection task. The connection task usually means that a user establishes a connection session with a core network function via a radio access network, to establish a channel and allocate a corresponding connection and an air interface resource for data transmission of the user, so that data transmission can be performed between the user and an external network. The task in this application is a process of completing an objective by collaborating various heterogeneous resources to provide various new service capabilities for a user.

It should be understood that the connection task may also be referred to as a connection service, a connecting service, or the like.

In a task-centric architecture, a task anchor (TA) and a task executor are introduced. The TA and the TE use the task as a management and control object, support managing and controlling a life cycle of the task, and collaborate and schedule the computing, algorithm, connection, and data resources to ensure task QoS, so as to ensure smooth task execution.

The TA may also be understood as a control plane function, and the TE is a data processing function. The TA is configured to provide a management and control function for the task. A control function may include managing the life cycle of the task, completing task deployment, starting, deletion, modification, monitoring, and the like based on a requirement of the task, and regulating a network resource to ensure the requirement of the task. In addition to the control function, the management and control function also has a function of selecting a node to perform a control function. For example, a first node having the management and control function may select a second node to perform the control function of the task. The TE is responsible for executing the task and performing data exchange in service logic. A task trigger source sends a task request to the TA, and the TA deploys the task on one or more TEs for execution.

To implement the foregoing task structure, this application provides a hierarchical RAN architecture, to provide a new service more efficiently.

The following describes the new service as a task-based service. This is not limited in embodiments of this application.

The following describes a network architecture provided in this application.

FIG. 2 is a diagram of a network architecture applicable to an embodiment of this application.

The network architecture is applicable to a 6G system (6GS).

The network architecture includes a 6GC architecture and a hierarchical RAN architecture.

In the hierarchical RAN architecture, a centralized coordinator node is introduced to provide intra-region and inter-region task coordination. For example, a RAN system includes a cluster control node (cNode) and a service serving node (sNode), and the cNode and the sNode jointly form a RAN node.

The cNode, namely, the cluster control node, provides a region-level centralized coordination function for a plurality of service serving nodes and a coordination function between cross-region cluster control nodes, provides a task anchor function in a cluster, and does not provide a connection function or provides only a connection control function in an air interface.

The sNode, namely, the service serving node, provides task scheduling and execution functions, and provides a connection control function and/or a data function in the air interface.

Optionally, the cNode and the sNode are respectively referred to as network elements (NEs), and this is not limited. If functions of the cNode and the sNode are split (a microservice-based architecture is used inside a base station), network functions inside the cNode and the sNode may be further defined.

The cNode may be responsible for a control plane function (for example, a TA) and a data processing function of a task-based service (for example, when the cNode has computing power, a task scheduler (TS) and a TE may be deployed, to execute a data processing task). The sNode is responsible for some of control plane and user plane functions, such as the TS and the TE, of the task-based service.

The RAN architecture provided in this application supports implementing service QOS assurance and resource coordination of a plurality of types of resources and a plurality of nodes in a form of a task. This finally brings a new dimension (evolving from a single dimension of a connection service to a new dimension of services such as connection, computing, data, intelligence, trustworthiness, algorithm, and sensing services encapsulated and provided in a form of a task) to a future wireless communication network, and implements service level agreement (SLA) assurance of various services such as AI, sensing, computing, and data services. Therefore, an application scenario of the wireless communication network is further expanded.

In the network architecture, different nodes communicate with each other through an interface.

For example, the cNode and the sNode are connected to each other through a Y1 interface, cNodes are connected to each other through a Y2 interface, and sNodes are connected to each other through a Y3 interface.

For another example, the cNode may be connected to the 6GC through a Tx interface. Specifically, the cNode is connected to a NAF through a T3 interface, is connected to a CF-C through a T4 interface, and is connected to a TCF/TPF through a T2 interface.

For another example, the sNode may be connected to the 6GC through a Ty interface. Specifically, the sNode is connected to a NAF through a T5 interface, is connected to a CF-C through a T6 interface, and is connected to a CF-U through a T7 interface.

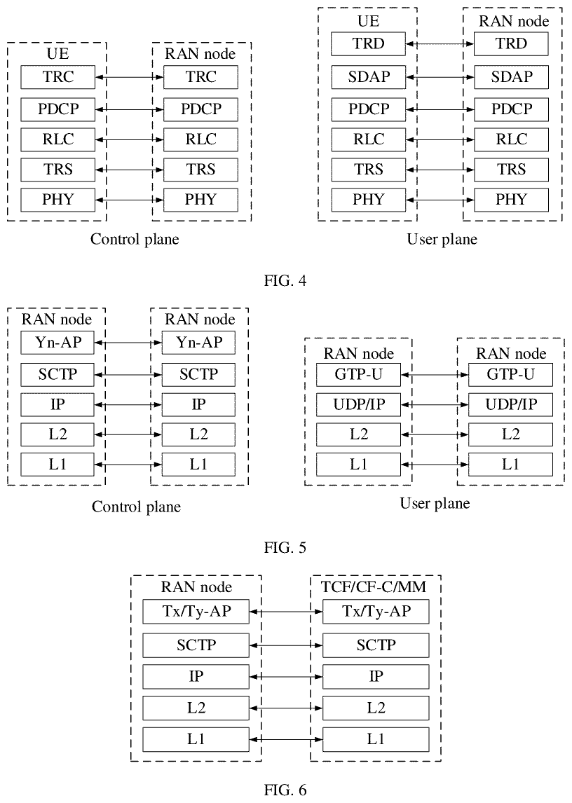

For 6GC network elements such as the NAF, the CF-C, the TCF, and the TPF, refer to descriptions in FIG. 4 below.

The foregoing interface name is merely an example for description, and is not limited in embodiments of this application.

FIG. 3 is a diagram of a core network architecture applicable to an embodiment of this application.

The network architecture includes but is not limited to: a network access function (NAF), a task process function (TPF), a connection control plane function (CF-C), a connection user plane function (CF-U), a mobility management (MM) function, a unified data management (UDM) function, a policy control function (PCF), and a task authentication and authorization (task authentication and authorization, TAA) function.

The core network architecture may be applied to 6G, to become a 6G core network (6GC or 6GCN).

The following briefly describes the network elements shown in FIG. 3.

1. The TPF provides task scheduling and execution functions on a core network side.

2. The CF-C and the CF-U respectively provide a control plane function and a user plane function of a connection.

3. The MM is mainly configured to provide a mobility management function of UE.

4. The TCF provides a task control function on the core network side.

5. The UDM provides functions such as subscription management, access authorization that is based on subscription data, and registration management of a network function serving the terminal.

6. The PCF provides a policy management function, including supporting a unified policy framework to manage network behavior, providing a policy rule, accessing policy-related subscription information, and the like.

7. The TAA provides initial or secondary authentication and authentication functions for a task.

In the network architecture shown in FIG. 3, the network elements may communicate with each other through interfaces.

It should be understood that the network architecture shown above is merely an example for description, and the network architecture applicable to embodiments of this application is not limited thereto. Any network architecture that can implement functions of the network elements is applicable to embodiments of this application.

It should be understood that the functions or network elements shown in FIG. 1 may be understood as network elements configured to implement different functions, for example, may be combined into a network slice based on a requirement. These network elements may be independent devices, may be integrated into a same device to implement different functions, may be network elements in a hardware device, may be software functions running on dedicated hardware, or may be virtualization functions instantiated on a platform (for example, a cloud platform). Specific forms of the network elements are not limited in this application.

It should be further understood that the foregoing names are defined merely for distinguishing between different functions, and should not constitute any limitation on this application. This application does not exclude a possibility of using other names in a 6G network and another future network. For example, in the 6G network, some or all of the foregoing network elements may still use terms in 5G, or may use other names.

This application includes communication between UE and a RAN node, communication between RAN nodes, and communication between the RAN node and a core network element. The following describes specific protocol stacks.

FIG. 4 shows a protocol stack architecture according to an embodiment of this application. The protocol stack architecture is a protocol stack between UE and a RAN node. A message is sent between the UE and the RAN node through a radio air interface (a Uu interface), and the protocol stack includes a control plane protocol and a user plane protocol.

The control plane protocol stack and the user plane protocol stack are shown in FIG. 4.

Signaling exchange is performed on a control plane, where task resource control (TRC) on the control plane may be an enhancement or evolution of an RRC radio resource (RRC) layer in an existing wireless communication protocol stack. Task control functions such as AI, computing, and data processing are added based on an existing radio resource control function.

Data exchange is performed on a user plane. A task resource scheduler (TRS) on the user plane may be an enhancement or evolution of a medium access control (MAC) layer in the existing wireless communication protocol stack. For example, a computing power scheduling function is additionally added based on an existing air interface resource scheduling function of the MAC layer. In addition, a task resource data (TRD) layer is added above a service data adaptation protocol (SDAP) layer, to provide task-related functions such as AI training/inference/model processing (compression/pruning/quantization/security).

The protocol layers shown in FIG. 4 are merely examples for description. These protocol layers may be added or deleted. This is not limited in embodiments of this application.

FIG. 5 shows a protocol stack architecture according to an embodiment of this application. The protocol stack architecture is a communication protocol stack between RAN nodes. The protocol stack includes a control plane protocol stack and a user plane protocol stack.

A control plane is used for signaling exchange, and a control plane interface is defined between the RAN nodes. A transport network layer is established above IP transmission. To reliably perform signaling message transmission, an SCTP is added above the IP layer. The SCTP layer provides guaranteed application layer message transferring. An application layer signaling protocol is referred to as a Yn-AP (Yn application protocol).

A user plane is used for data transmission, and a user plane signaling interface is defined between the RAN nodes. A transport network layer is established above IP transmission. A GTP-U is used above a UDP/IP to carry a user plane PDU between the RAN nodes.

The RAN nodes communicate with each other through an interface, for example, a Yn interface. An interface name is not limited in embodiments of this application, and the interface may alternatively have another name.

For example, a cNode and an sNode are connected to each other through a Y1 interface, cNodes are connected to each other through a Y2 interface, and sNodes are connected to each other through a Y3 interface.

The foregoing is merely an example for description. In embodiments of this application, an interface name is not limited, and the interface may alternatively have another name.

The protocol layers shown in FIG. 5 are merely examples for description. These protocol layers may be added or deleted. This is not limited in embodiments of this application.

FIG. 6 shows a protocol stack architecture according to an embodiment of this application. The protocol stack architecture is a communication protocol stack between a RAN node and a core network.

A control plane is used for signaling exchange, and a control plane interface is defined between the RAN node and a core network element. A transport network layer is established above IP transmission. To reliably perform signaling message transmission, an SCTP is added above the IP layer. The SCTP layer provides guaranteed application layer message transferring. An application layer signaling protocol is referred to as a Tx/Ty-AP (Tx/Ty application protocol).

The RAN node communicates with the core network element through interfaces. For example, the communication interfaces are Tx and Ty. In embodiments of this application, an interface name is not limited, and the interface may alternatively have another name.

For example, a cNode is connected to a 6GC through a Tx interface. More specifically, the cNode is connected to a NAF through a T3 interface, the cNode is connected to a CF-C through a T4 interface, and the cNode is also connected to a TCF/TPF through a T2 interface. An sNode is further connected to the 6GC through a Ty interface. More specifically, the sNode is connected to the NAF through a T5 interface, is connected to the CF-C through a T6 interface, and is connected to a CF-U through a T7 interface.

The foregoing is merely an example for description. In embodiments of this application, an interface name is not limited, and the interface may alternatively have another name.

The protocol layers shown in FIG. 6 are merely examples for description. These protocol layers may be added or deleted. This is not limited in embodiments of this application.

In this application, task management is performed between the cNode and the sNode through the Y1 interface; a task negotiation function is performed between the cNodes through the Y2 interface; inter-region task negotiation is performed between the cNode and the TCF through the T2 interface; and task signaling or data exchange between TEs is performed between the sNodes through the Y3 interface. Task control between network elements may be control of the cNode on the sNode, task negotiation between the cNodes, and task negotiation between the TCF and the cNode.

A future wireless communication network is to natively support a plurality of tasks, including computing, artificial intelligence (AI), sensing, data processing, and the like. Therefore, in addition to a conventional connection session service, the user equipment (UE) may further initiate a task request to a network. To implement service decoupling, a TA and a TE are independently deployed in both a core network (CN) and a radio access network (RAN). For example, on a core network side, a TCF (task control function) provides a TA function, and a TPF (task process function) provides a TE function; and on an access network side, a cNode provides the TA function, and an sNode provides the TE function.

Therefore, the UE (user equipment) may be used as a task trigger source to initiate the task request to a TA in the network. In a scenario in which TAs are respectively deployed in the core network and the access network independently, how to deploy a task and meet the task request of the UE is an urgent problem to be resolved. In other words, how to determine a TA that controls execution of the task is a key problem in implementing deployment and management of the task of the UE.

In this application, the TAs are respectively deployed in the core network and the access network independently. The terminal device may initiate the task request to the TA in the core network, or may initiate the task request to the TA in the access network. The following describes this solution in detail.

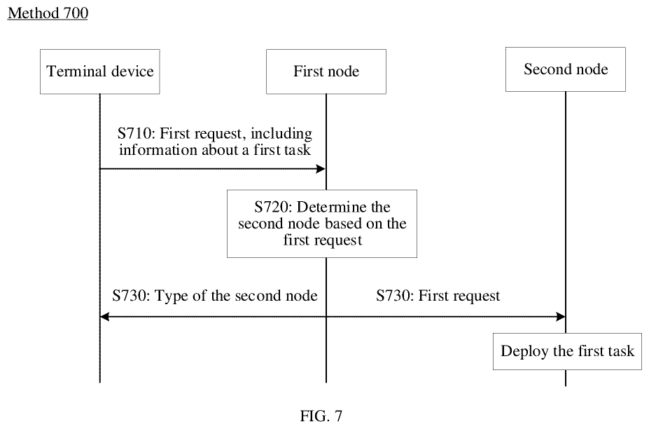

FIG. 7 is a block diagram of a task-based communication method 700 according to an embodiment of this application.

In this embodiment, an example in which a terminal device and a network device (a first node and a second node) are used as execution bodies of interaction illustration is used to illustrate the method. However, the execution body of the interaction illustration is not limited in this application. For example, the network device in FIG. 7 may alternatively be a chip, a chip system, or a processor that supports the method that can be implemented by the network device, or may be a logical module or software that can implement all or some functions of the network device. The terminal device in FIG. 7 may alternatively be a chip, a chip system, or a processor that supports the method that can be implemented by the terminal device, or may be a logical module or software that can implement all or some functions of the terminal device.

In this application, a first task includes a process of implementing a service objective based on collaboration of heterogeneous resources. The heterogeneous resource may include a computing resource, an intelligence resource, a data resource, a sensing resource, and the like. The service objective may include model training, model inference, high-precision positioning, and the like.

In other words, the first task is a task-based service provided by using a multi-dimensional heterogeneous resource collaboration capability, for example, various new service capabilities such as computing, data processing, trustworthiness, intelligence, and sensing.

The first node in this application may be a network node having a TA function, in other words, the first node is configured to provide a management and control function for the first task.

The second node in this application is a TA that is selected by the first node and that controls execution of the first task. The second node may be the first node, or may be another node.

The method 700 may include the following steps.

S710: The terminal device sends a first request to the first node.

The terminal device determines the first node, and sends the first request to the first node. Correspondingly, the first node receives the first request from the terminal device.

The first request is used to request the first node to control execution of the first task. The first task includes the process of implementing the service objective based on the collaboration of the heterogeneous resources.

Requesting to control execution of the first task may be understood as requesting to use the first task as a management and control object, complete one or more of task deployment, starting, deletion, modification, and monitoring based on a requirement of the first task, and regulate a network resource to ensure the requirement of the first task. Specifically, a TE needs to be deployed to be responsible for specific execution of the first task. Further, the TE performs data exchange in service logic with the TA.

The first request includes information about the first task.

For example, the information about the first task may include one or more of an identifier of the terminal device, a type of the first task, an identifier of the first task, a task description of the first task, and the requirement of the first task. The requirement of the first task may be, for example, a resource requirement or a QoS requirement.

Optionally, the first request may further include first configuration information, and the first configuration information includes related configurations such as a computing power configuration and/or an algorithm configuration for executing the first task.

In this application, the first node may be a TA deployed in an access network, and the first node may be an access network device accessed by the terminal device, or may be another access network device, for example, a cNode. Alternatively, the first node may be a TA deployed in a core network, for example, a TCF network element serving the terminal device.

When the first node is the TA deployed in the core network, the terminal device sends the first request by using task non-access stratum (T-NAS) signaling. Correspondingly, the first node receives the first request by using the T-NAS signaling.

When the first node is the TA deployed in the access network, the terminal device sends the first request by using TRC signaling. Correspondingly, the first node receives the first request by using the TRC signaling.

In this application, the T-NAS signaling is task-based NAS signaling. It should be understood that a communication protocol stack of a task-centric network architecture includes a control plane protocol stack and a user plane protocol stack of a task. A control plane includes an enhanced NAS (T-NAS) layer, a TRC layer, a TRS layer, and the like. A user plane includes a TRD layer and an enhanced SDAP (T-SDAP) layer.

“T-NAS” and “T-SDAP” are merely names defined for ease of understanding in this embodiment of this application. This is not limited in embodiments of this application.

It should be understood that, the TA in the core network exchanges task control signaling with the UE through a T-NAS interface. For example, the TCF exchanges the task control signaling with the UE through the T-NAS interface. The TA in the access network exchanges task control signaling with the UE through a TRC interface or via an sNode. For example, the cNode exchanges the task control signaling with the UE through the TRC interface or via the sNode.

In an optional implementation, the UE determines the first node based on a connected sNode. The UE sends the first request to the first node via the sNode.

In another optional implementation, the terminal device determines a type of the second node based on a first mapping relationship, and the terminal device determines the first node based on the type of the second node, where a type of the first node is the same as the type of the second node. The second node is a TA that controls the first task. In other words, before sending the first request, the terminal device obtains a type of the TA in advance, and may determine the first node of the same type based on the type, and send the first request to the first node.

The first mapping relationship indicates a correspondence between an event of the first task and the type of the second node.

For example, the first mapping relationship may be a correspondence between the first task and the type of the second node, or the first mapping relationship may be a correspondence between the type of the first task and the type of the second node.

For example, the first mapping relationship may be predefined in a protocol.

For example, the UE may obtain the first mapping relationship or update of the first mapping relationship via a core network device or an access network device.

The first node may send the first mapping relationship or the update information of the first mapping relationship to the UE in the following several example manners.

Manner 1: A UE registration procedure includes initial registration, mobility registration update, and periodic registration update. The first mapping relationship may be configured for the UE in the registration procedure.

Manner 2: For a UE configuration update procedure, when the first mapping relationship changes, the TCF may trigger the UE configuration update procedure, and send a configuration update message to the UE, where the configuration update message carries an updated first mapping relationship. After performing local updating, the UE returns a configuration update acknowledgment to the TCF.

Manner 3: A paging procedure includes paging initiated by the access network or paging initiated by the core network, and a corresponding paging message includes the first mapping relationship.

The foregoing manners are merely examples for description, and do not constitute any limitation on this embodiment of this application.

Optionally, after receiving the first request, the first node may further send a task authentication and authentication request to a task authentication and authentication function network element of the core network based on the information about the first task, where the authentication and authentication request includes the information about the first task. Correspondingly, after completing authentication and authentication by obtaining subscription information of a terminal device and the like based on the information about the first task, the task authentication and authentication function network element sends acknowledgment information to the first node.

For example, if the first node determines, based on the information about the first task, that the first task is not of a task type known to the first node, the first node may request task authentication and authentication from the task authentication and authentication function network element of the core network. The task authentication and authentication function network element of the core network may be TAA (task authentication and authorization). The TAA is a logical function of the core network, and may be provided in a core network function such as a UDM or a PCF. This is not limited in embodiments of this application.

S720: The first node determines the second node based on the first request. The second node is configured to control execution of the first task.

In a possible implementation, the first node determines the second node based on the information about the first task included in the first request.

For example, the first node selects the second node based on one or more of the identifier of the terminal device, the type of the first task, the identifier of the first task, the task description of the first task, the requirement of the first task, and the like.

In a possible implementation, the first request sent by the terminal device is sent based on the type of the second node, and the type of the second node is determined by the terminal device based on the first mapping relationship. In this case, the first node may select a node of the same type as the second node.

For example, the first node selects, as the second node, the node of the same type as the first node based on one or more of the identifier of the terminal device, the type of the first task, the identifier of the first task, the task description of the first task, the requirement of the first task, and the like.

For example, the second node may be a TCF, or may be a cNode.

It should be understood that the second node may alternatively be the first node.

S730: The first node sends the type of the second node to the terminal device, or the first node sends the first request to the second node.

The type of the second node includes a core network element or an access network element, that is, the TA in the core network or the TA in the access network.

Case 1: The first node sends the type of the second node to the terminal device.

In this case, in a possible implementation, after determining the second node, the first node sends the type of the second node to the terminal device.

Correspondingly, the terminal device forwards the first request to the second node based on the type of the second node via an access network element of the terminal device.

It should be understood that the terminal device determines, based on the type of the second node, to send the first request by using the T-NAS signaling or send the first request by using the TRC signaling.

For example, if the type of the second node is the core network element, the terminal device sends the first request by using the T-NAS signaling. If the type of the second node is the access network element, the terminal device sends the first request by using the TRC signaling.

For example, if the first node is a TCF, and the access network element connected to the terminal device is a cNode, the TCF may further send an identifier of the second node to the cNode. If the second node is the access network element, the terminal device sends the first request to the cNode by using the TRC signaling. The cNode determines the second node based on the identifier of the second node, and forwards the first request to the second node, and the second node deploys a corresponding TE to execute the first task.

For example, if the first node is a TCF, and the access network element connected to the terminal device is a cNode, the TCF may further send an identifier of the second node to the cNode. If the second node is the core network element, the terminal device sends the first request to the cNode by using the T-NAS signaling. The cNode determines the second node based on the identifier of the second node, and forwards the first request to the second node, and the second node deploys a corresponding TE to execute the first task.

For example, if the first node is a TCF, and the second node determined by the TCF is a cNode, the TCF may not send an identifier of the second node to the cNode. The terminal device sends the first request to the cNode based on the type of the second node, and the cNode determines, based on the first request, that the cNode is the second node. In other words, the cNode deploys a corresponding TE to execute the first task.

For example, if the first node is a cNode, the cNode is the access network element connected to the terminal device, and the second node determined by the cNode is another access network element, the terminal device sends the first request to the cNode by using the TRC signaling, the cNode determines the second node, and forwards the first request to the second node, and the second node deploys a corresponding TE to execute the first task.

For example, if the first node is a cNode, the cNode is the access network element connected to the terminal device, and the second node determined by the cNode is the cNode, the terminal device sends the first request to the cNode by using the TRC signaling, and the cNode deploys a corresponding TE to execute the first task.

For example, if the first node is a cNode, the cNode is the access network element connected to the terminal device, and the second node determined by the cNode is the core network element, the terminal device sends the first request to the cNode by using the T-NAS signaling, the cNode determines the second node, and forwards the first request to the second node, and the second node deploys a corresponding TE to execute the first task.

Optionally, the terminal device determines, based on the type of the second node, to send the first configuration information to the second node by using the T-NAS signaling, or send the first configuration information by using the TRC signaling.

For example, if the type of the second node is the core network element, the terminal device sends the first configuration information to the second node by using the T-NAS signaling. If the type of the second node is the access network element, the terminal device sends the first configuration information by using the TRC signaling.

Case 2: The first node forwards the first request to the second node.

In this case, in a possible implementation, after the first node determines the second node, the first node does not send the type of the second node to the terminal device, but forwards the first request to the second node.

Correspondingly, after receiving the first request, the second node deploys, based on the information about the first task in the first request, a corresponding TE to execute the first task.

For example, if the first node is a TCF, and it is determined that the second node is a cNode, the first node sends the first request to the cNode, and the cNode deploys a corresponding TE to execute the first task.

For example, if the first node is a TCF, and it is determined that the second node is another core network element, the first node sends the first request to the another core network element, and the another core network element deploys a corresponding TE to execute the first task.

For example, if the first node is a cNode, and it is determined that the second node is a TCF, the first node sends the first request to the TCF, and the TCF deploys a corresponding TE to execute the first task.

For example, if the first node is a cNode, and it is determined that the second node is another access network element, the first node sends the first request to the another access network element, and the another access network element deploys a corresponding TE to execute the first task.

For example, if the first node determines that the second node is the first node, the first node does not need to forward the first request to the second node, and the first node deploys a corresponding TE to execute the first task.

Optionally, the first node may further forward the first configuration information to the second node.

Optionally, the first node may further send registration information to a mobility management function, where the registration information is used to register a binding relationship between the first task and the second node with the mobility management function, and the registration information includes the identifier of the terminal device, the identifier of the first task, and the identifier of the second node.

In an optional manner, after determining the second node of the first task, the first node registers a context of the first task with the mobility management function. When the terminal device moves, for example, moves to a new TA node region, the mobility management function may trigger the TA to perform handover.

In the foregoing solution, a solution in which the terminal device sends a task request to the TA in the core network or the TA in the access network is described through interaction between the terminal device and the first node. The following describes in detail specific solutions of different interaction bodies.

First, an example solution in which a terminal device sends a task request to a TA in a core network is described.

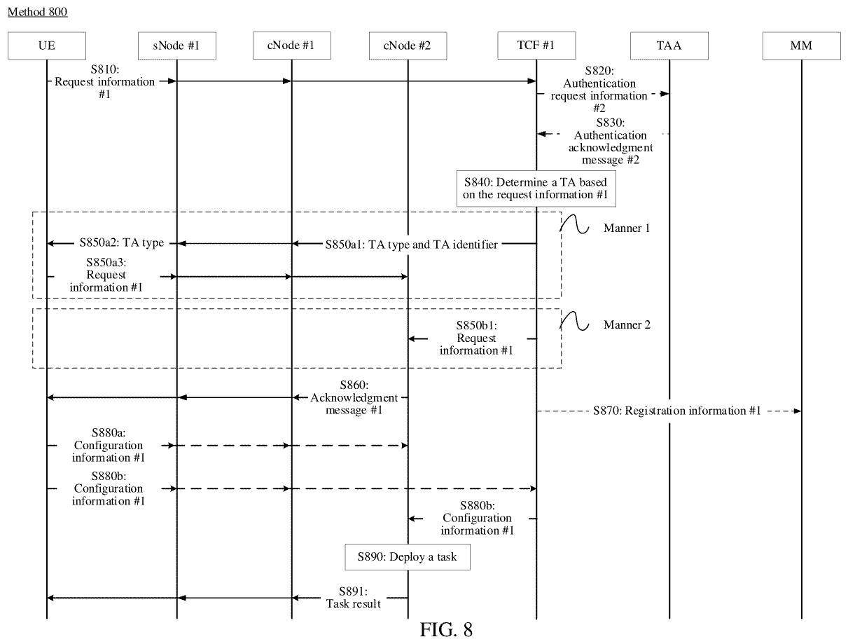

FIG. 8 is a diagram of a task-based communication method 800 according to an embodiment of this application.

In this embodiment, an example in which a TA in a core network is a TCF #1 is used. It is assumed that an access network device currently connected to a terminal device is an sNode #1, a cluster node associated with the sNode #1 is a cNode #1, and the cNode #1 may be located in a service region of the TCF #1. The UE needs to initiate a request of a task #A to a network, where the task #A is a first task.

The method 800 may include the following steps.

S810: The UE sends request information #1 to the TCF #1. The request information #1 includes information related to the task #A.

The UE sends the request information #1 to the sNode #1, and the sNode #1 sends the request information #1 to the TCF #1 via the cNode #1.

Correspondingly, the TCF #1 receives the request information #1 via the cNode #1.

The request information #1 is used to request the TCF #1 to control execution of the task #A.

The UE sends the request information #1 to the TCF #1 by using T-NAS signaling.

Correspondingly, the TCF #1 receives the request information #1 by using the T-NAS signaling.

The information related to the task #A includes, for example, one or more of an identifier of the UE, a type of the task #A, an identifier of the task #A, a task description of the task #A, a requirement of the task #A, and the like.

Optionally, the request information #1 may further include configuration information #1, and the configuration information #1 includes related configurations such as a computing power configuration and/or an algorithm configuration for executing the task #A.

S820: The TCF #1 sends authentication request information #1 to TAA.

Correspondingly, the TAA receives the request information #1 from the TCF #1.

The authentication request information #1 is used to request task authentication and authentication from the TAA.

The authentication request information #1 includes the information about the task #A, for example, one or more of the identifier of the UE, the type of the task #A, the task description of the task #A, the requirement of the task #A, and the like.

It should be understood that, if the TCF #1 determines, based on the request information #1, that the task #A is not of an existing task type, the TCF #1 sends the authentication request information #1 to the TAA.

S830: The TCF #1 receives an authentication acknowledgment message #1 from the TAA.

The TAA completes authentication and authentication by obtaining subscription information of the UE and the like based on the authentication request information #1, and sends the authentication acknowledgment message #1 to the TCF #1, to complete authentication and authentication on the task #A.

It should be understood that step S820 and step S830 are optional steps.

S840: The TCF #1 determines a TA based on the request information #1.

The TCF #1 determines the TA based on the information about the task #A in the request information #1.

For example, the TCF #1 determines the TA based on one or more of the identifier of the UE, the type of the task #A, the task description of the task #A, the requirement of the task #A, and the like.

It should be understood that the TA may be the TA in the core network, or may be a TA in an access network, or may be the TCF #1. In the solution shown in FIG. 8, an example in which a selected TA is a cNode #2 is used for description. However, this does not constitute any limitation on this embodiment of this application.

After determining the TA, the TCF #1 sends a task request to the TA in two manners. Manner 1 includes steps S850a1 to S850a3, and Manner 2 includes step S850b1.

Manner 1 is first described.

S850a1: The TCF #1 sends an identifier of the TA to the cNode #1.

S850a2: The TCF #1 sends a type of the TA to the UE.

S850a3: The UE sends request information #1 to the TA based on the type of the TA via the sNode #1 and the cNode #1.

For example, when the TA is the cNode #2, the UE determines, based on the type of the TA, to forward the request information #1 to the sNode #1 by using TRC signaling, the sNode #1 forwards the request information #1 to the cNode #1, and the cNode #1 sends the request information #1 to the cNode #2 based on the identifier of the TA.

For example, when the TA is another TCF (a TCF #2), the UE determines, based on the type of the TA, to forward the request information #1 to the sNode #1 by using T-NAS signaling, the sNode #1 forwards the request information #1 to the cNode #1, and the cNode #1 sends the request information #1 to the TCF #2 based on the identifier of the TA.

It should be understood that, if the type of the TA is a core network element, the UE sends the request information #1 by using the T-NAS signaling.

It should be understood that if the TA determined by the TCF #1 is the cNode #1, the identifier of the TA may not be sent to the cNode #1.

It may be understood that the request information #1 sent in this step and the request information #1 sent in S810 carry same content, and sending signaling is different.

Manner 2 is described below.

S850b1: The TCF #1 sends request information #1 to the cNode #2.

Correspondingly, the cNode #2 receives the request information #1 from the TCF #1.

For example, when the TA is a TCF #2, the TCF #1 sends the request information #1 to the TCF #2.

After determining the TA, the TCF #1 directly sends the request information #1 to the TA.

It may be understood that the request information #1 sent in this step and the request information #1 sent in S810 carry same content, and sending signaling is different.

S860: The cNode #2 sends an acknowledgment message #1 to the UE.

The cNode #2 sends the acknowledgment message #1 to the cNode #1, and the cNode #1 forwards the acknowledgment message #1 to the UE via the sNode #1.

For example, when the TA is the TCF #2, the TCF #2 sends the acknowledgment message #1 to the UE via the cNode #1 and the sNode #1.

The acknowledgment message #1 is used to acknowledge the task request to the UE.

S870: The TCF #1 sends registration information #1 to MM.

Correspondingly, the MM receives the registration information #1 from the TCF #1.

The registration information #1 is used to register context information of the task #A with the MM, and the registration information #1 includes the identifier of the UE, the identifier of the task #A, and the identifier of the TA.

In an optional understanding, after determining the TA of the task #A, the TCF #1 registers a context of the task #A with a mobility management function. When the UE moves, for example, moves to a new TA node region, the mobility management function may trigger the TA to perform handover.

It may be understood that the UE may send the configuration information #1 to the TA by using the request information #1, or may send the configuration information #1 by using an independent message.

S880a: The UE sends the configuration information #1 to the cNode #2 via the sNode #1 and the cNode #1.

It may be understood that, after obtaining the type of the TA, the UE may directly send the configuration information #1 to the cNode #2 by using the TRC signaling.

For example, when the TA is the TCF #2, the UE sends the configuration information #1 to the TCF #2 by using the T-NAS signaling.

S880b: The UE sends the configuration information #1 to the TCF #1, and the TCF #1 forwards the configuration information #1 to the cNode #2.

It may be understood that the UE may directly send the configuration information #1 to the TCF #1 by using the T-NAS signaling, and forward the configuration information #1 to the cNode #2 via the TCF #1.

For example, when the TA is the TCF #2, the UE sends the configuration information #1 to the TCF #1 by using the T-NAS signaling, and then forwards the configuration information #1 to the TCF #2 via the TCF #1.

S890: The cNode #2 deploys the task.

The cNode #2 deploys the task on one or more TEs for execution based on the configuration information #1 and the task request.

For example, the TE may be an sNode connected to the cNode #2.

For example, if the TA is the TCF #2, the TCF #2 deploys the task. In this case, the TE may be an access network element served by the TCF #2.

S891: The cNode #2 sends a task result to the UE.

After executing the task, each executor reports an execution result to the cNode #2 for summarization, and then the cNode #2 sends a final task result to the UE via the cNode #1 and the sNode #1.

For example, if the TA is the TCF #2, the TCF #2 sends the task result to the UE.

In this technical solution, the UE sends the task request to a TCF in the core network; the TCF selects the TA based on the task request; and the TCF indicates the type of the TA to the UE, and the UE sends the task request to the TA based on the type of the TA; or the TCF directly forwards the task request to the TA, and the TA completes task deployment. The TCF in the core network selects the TA, so that complexity of the UE can be reduced; and the UE senses the type of the TA, so that efficiency of subsequently sending a task message by the UE can be improved.

The following describes an example solution in which a terminal device sends a task request to a TA in an access network.

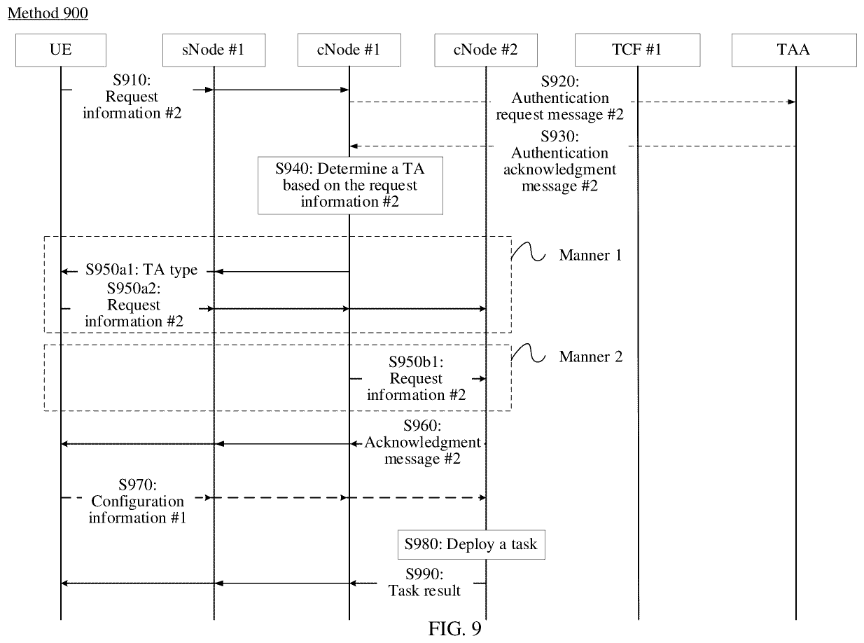

FIG. 9 is a diagram of a task-based communication method 900 according to an embodiment of this application.

In this embodiment, an example in which a TA in an access network is a cNode #1 is used. It is assumed that an access network device currently connected to a terminal device is an sNode #1, a cluster node associated with the sNode #1 is a cNode #1, and the cNode #1 may be located in a service region of a TCF #1. The UE needs to initiate a request of a task #A to a network, where the task #A is a first task.

The method 900 may include the following steps.

S910: The UE sends request information #2 to the cNode #1. The request information #2 includes information related to the task #A.

The UE sends the request information #2 to the sNode #1, and the sNode #1 sends the request information #2 to the cNode #1.

Correspondingly, the cNode #1 receives the request information #2 via the sNode #1.

The request information #2 is used to request the cNode #1 to control execution of the task #A.

The UE sends the request information #2 to the cNode #1 by using TRC signaling.

Correspondingly, the cNode #1 receives the request information #2 by using the TRC signaling.

The request information #2 includes the information related to the task #A, for example, includes one or more of an identifier of the UE, a type of the task #A, a task description of the task #A, a requirement of the task #A, and the like.

Optionally, the request information #2 may further include configuration information #1, and the configuration information #1 includes related configurations such as a computing power configuration and/or an algorithm configuration for executing the task #A.

S920: The cNode #1 sends authentication request information #2 to TAA.

Correspondingly, the TAA receives the authentication request information #2 from the cNode #1.

The authentication request information #2 is used to request task authentication and authentication from the TAA.

The authentication request information #2 includes the information about the task #A, for example, one or more of the identifier of the UE, the type of the task #A, the task description of the task #A, the requirement of the task #A, and the like.

It should be understood that, if the cNode #1 determines, based on the request information #2, that the task #A is not of an existing task type, the cNode #1 sends the authentication request information #2 to the TAA.

S930: The cNode #1 receives an authentication acknowledgment message #2 from the TAA.

The TAA completes authentication and authentication by obtaining subscription information of the UE and the like based on the authentication request information #2, and sends the authentication acknowledgment message #2 to the cNode #1, to complete authentication and authentication on the task #A.

It should be understood that step S920 and step S930 are optional steps.

S940: The cNode #1 determines a TA based on the request information #2.

The cNode #1 determines the TA based on the information about the task #A in the request information #2.

For example, the cNode #1 determines the TA based on one or more of the identifier of the UE, the type of the task #A, the task description of the task #A, the requirement of the task #A, and the like.

It should be understood that the TA may be a TA in a core network, or may be the TA in the access network, or may be the cNode #1. In the solution shown in FIG. 9, an example in which a selected TA is a cNode #2 is used for description. However, this does not constitute any limitation on this embodiment of this application.

After determining the TA, the cNode #1 sends a task request to the TA in two manners. Manner 1 includes steps S950a1 and S950a2, and Manner 2 includes step S950b1.

Manner 1 is first described.

S950a1: The cNode #1 sends a type of the TA to the UE.

S950a2: The UE sends request information #2 to the TA based on the type of the TA via the sNode #1 and the cNode #1.

For example, when the TA is the cNode #2, the UE determines, based on the type of the TA, to forward the request information #2 to the sNode #1 by using TRC signaling, the sNode #1 forwards the request information #2 to the cNode #1, and the cNode #1 sends the request information #2 to the cNode #2 based on an identifier of the TA.

For example, when the TA is another TCF (a TCF #2), the UE determines, based on the type of the TA, to forward the request information #2 to the sNode #1 by using T-NAS signaling, the sNode #1 forwards the request information #2 to the cNode #1, and the cNode #1 sends the request information #2 to the TCF #2 based on an identifier of the TA.

It should be understood that, if the type of the TA is a core network element, the UE sends the request information #2 by using the T-NAS signaling.

It may be understood that the request information #2 sent in this step and the request information #2 sent in S910 carry same content, and sending signaling is different.

Manner 2 is described below.

S950b1: The cNode #1 sends request information #2 to the cNode #2.

Correspondingly, the cNode #2 receives the request information #2 from the cNode #1.

For example, when the TA is a TCF #2, the cNode #1 sends the request information #2 to the TCF #2.

After determining the TA, the cNode #1 directly sends the request information #2 to the TA.

It may be understood that the request information #2 sent in this step and the request information #2 sent in S910 carry same content, and sending signaling is different.

S960: The cNode #2 sends an acknowledgment message #2 to the UE.

The cNode #2 sends the acknowledgment message #2 to the cNode #1, and the cNode #1 forwards the acknowledgment message #2 to the UE via the sNode #1.

For example, when the TA is the TCF #2, the TCF #2 sends the acknowledgment message #2 to the cNode #1, and the cNode #1 forwards the acknowledgment message #2 to the UE via the sNode #1.

The acknowledgment message #2 is used to acknowledge the task request to the UE.

It may be understood that the UE may send the configuration information #1 to the TA by using the request information #2, or may send the configuration information #1 by using an independent message.

S970: The UE sends the configuration information #1 to the cNode #2 via the sNode #1 and the cNode #1.

It may be understood that, after obtaining the type of the TA, the UE may directly send the configuration information #1 to the cNode #2 by using the TRC signaling.

For example, when the TA is the TCF #2, the UE sends the configuration information #1 to the TCF #2 by using the T-NAS signaling.

S980: The cNode #2 deploys the task.

The cNode #2 deploys the task on one or more TEs for execution based on the configuration information #1 and the task request.

For example, the TE may be an sNode connected to the cNode #2.

For example, if the TA is the TCF #2, the TCF #2 deploys the task. In this case, the TE may be an access network element served by the TCF #2.

S990: The cNode #2 sends a task result to the UE.

After executing the task, each executor reports an execution result to the cNode #2 for summarization, and then the cNode #2 sends a final task result to the UE via the cNode #1 and the sNode #1.

For example, if the TA is the TCF #2, the TCF #2 sends the task result to the UE.

In this technical solution, the UE sends the task request to a cNode in the access network; the cNode selects the TA based on the task request; and the cNode indicates the type of the TA to the UE, and the UE sends the task request to the TA based on the type of the TA; or the cNode directly forwards the task request to the TA, and the TA completes task deployment. The cNode in the access network selects the TA, so that complexity of the UE can be reduced; and the UE senses the type of the TA, so that efficiency of subsequently sending a task message by the UE can be improved.

The following describes an example solution in which UE sends a task request to a TA in a core network, and all task signaling of the UE is forwarded by a TCF in the core network to the TA.

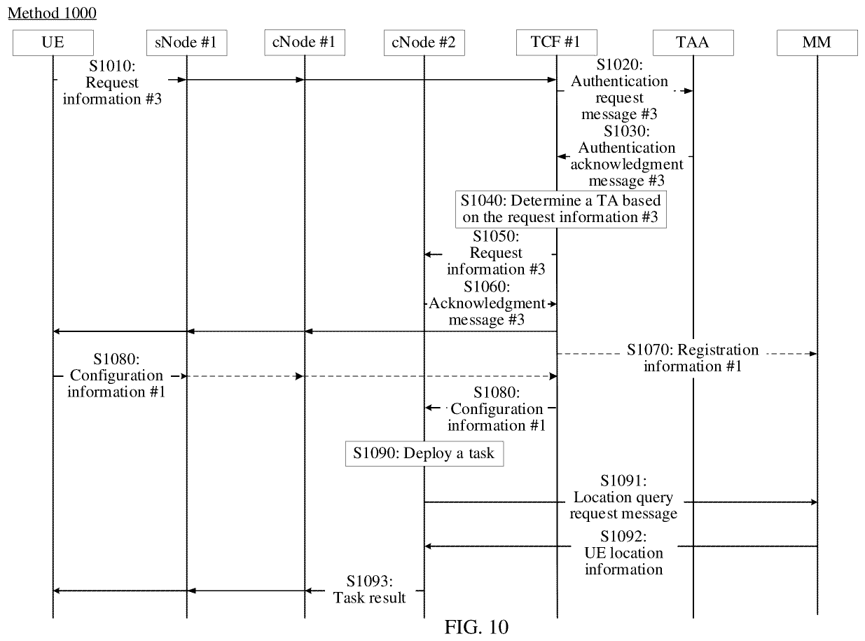

FIG. 10 is a diagram of a task-based communication method 1000 according to an embodiment of this application.

In this embodiment, an example in which a TA in a core network is a TCF #1 is used. It is assumed that an access network device currently connected to a terminal device is an sNode #1, a cluster node associated with the sNode #1 is a cNode #1, and the cNode #1 may be located in a service region of the TCF #1. The UE needs to initiate a request of a task #A to a network, where the task #A is a first task.

The method 1000 may include the following steps.

S1010: The UE sends request information #3 to the TCF #1. The request information #3 includes information related to the task #A.

S1020: The TCF #1 sends authentication request information #3 to TAA.

S1030: The TCF #1 receives an authentication acknowledgment message #3 from the TAA.

S1040: The TCF #1 determines a TA based on the request information #3.

For a specific solution of steps S1010 to S1040, refer to S810 to S840 in the method 800. Details are not described herein again.

In the solution shown in FIG. 10, an example in which the TA determined by the TCF #1 is a cNode #2 is used.

In this embodiment, all task signaling is forwarded by the TCF #1.

S1050: The TCF #1 sends request information #3 to the cNode #2.

Correspondingly, the cNode #2 receives the request information #3 from the TCF #1.

For example, when the TA is a TCF #2, the TCF #1 sends the request information #3 to the TCF #2.

After determining the TA, the TCF #1 directly sends the request information #3 to the TA.

It may be understood that the request information #3 sent in this step and the request information #3 sent in S1010 carry same content, and sending signaling is different.

S1060: The cNode #2 sends an acknowledgment message #3 to the UE via the TCF #1.

The cNode #2 forwards the acknowledgment message #3 to the cNode #1 via the TCF #1, and the cNode #1 forwards the acknowledgment message #3 to the UE via the sNode #1.

For example, when the TA is the TCF #2, the TCF #2 sends the acknowledgment message #3 to the UE via the cNode #1 and the sNode #1.

The acknowledgment message #3 is used to acknowledge a task request to the UE.

S1070: The TCF #1 sends registration information #1 to MM.

For a specific solution of step S1070, refer to S870 in the method 800. Details are not described herein again.

S1080: The UE sends configuration information #1 to the TCF #1, and the TCF #1 forwards the configuration information #1 to the cNode #2.

It may be understood that the UE may directly send the configuration information #1 to the TCF #1 by using T-NAS signaling, and forward the configuration information #1 to the cNode #2 via the TCF #1.

For example, when the TA is the TCF #2, the UE may send the configuration information #1 to the TCF #1 by using the T-NAS signaling, and then forward the configuration information #1 to the TCF #2 via the TCF #1. Alternatively, the UE may directly send the configuration information #1 to the TCF #2 by using the T-NAS signaling.

S1090: The cNode #2 deploys the task.

The cNode #2 deploys the task on one or more TEs for execution based on the configuration information #1 and the task request.

For example, the TE may be an sNode connected to the cNode #2.

For example, if the TA is the TCF #2, the TCF #2 deploys the task. In this case, the TE may be an access network element served by the TCF #2.

S1091: The cNode #2 sends location query request information to MM.

After the task is completed, the cNode #2 collects a task execution result and queries the MM for a current location of the UE by using the location query request information.

S1092: The cNode #2 receives UE location information from the MM.

The MM sends the UE location information to the cNode #2, where the UE location information includes identification information of the sNode #1 currently connected to the UE and the cNode #1.

Correspondingly, the cNode #2 determines, based on identifiers of the sNode #1 and the cNode #1, a path for sending a task result to the UE.

S1093: The cNode #2 sends the task result to the UE.

After executing the task, each executor reports an execution result to the cNode #2 for summarization, and then the cNode #2 sends a final task result to the UE via the cNode #1 and the sNode #1.

For example, if the TA is the TCF #2, the TCF #2 sends the task result to the UE.

In this technical solution, the UE sends the task request to a TCF in the core network, the TCF selects the TA based on the task request, the TCF forwards messages such as the task request and a task configuration to the TA, and the TA completes task deployment. All task signaling sent by the UE is forwarded by the TCF, and the UE does not need to sense the type of the TA, thereby reducing complexity of a UE side and air interface signaling.

The following describes an example solution in which a terminal device sends a task request to a TA in an access network, and all task signaling of UE is forwarded by a cNode to the TA.

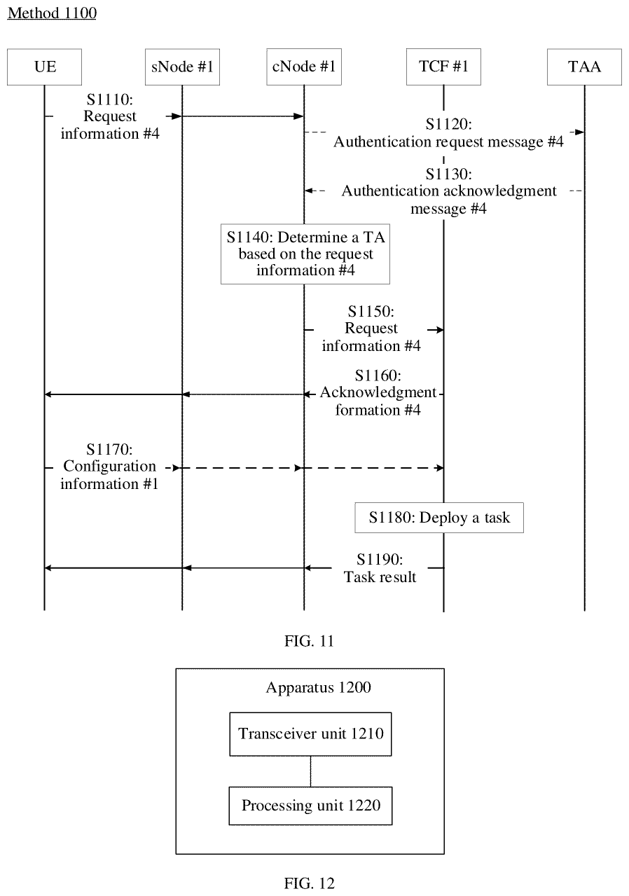

FIG. 11 is a diagram of a task-based communication method 1000 according to an embodiment of this application.

In this embodiment, an example in which a TA in an access network is a cNode #1 is used. It is assumed that an access network device currently connected to a terminal device is an sNode #1, a cluster node associated with the sNode #1 is a cNode #1, and the cNode #1 may be located in a service region of a TCF #1. The UE needs to initiate a request of a task #A to a network, where the task #A is a first task.

The method 1100 may include the following steps.

S1110: The UE sends request information #4 to the cNode #1. The request information #4 includes information related to the task #A.

S1120: The cNode #1 sends authentication request information #4 to TAA.

S1130: The cNode #1 receives an authentication acknowledgment message #4 from the TAA.

It should be understood that step S1120 and step S1130 are optional steps.

S1140: The cNode #1 determines a TA based on the request information #4.

For a specific solution of steps S1110 to S1140, refer to S910 to S940 in the method 900. Details are not described herein again.

In the solution shown in FIG. 11, an example in which the TA determined by the cNode #1 is a TCF #1 is used.

In this embodiment, all task signaling is forwarded by the cNode #1.

S1150: The cNode #1 sends request information #4 to the TCF #1.

Correspondingly, the TCF #1 receives the request information #4 from the cNode #1.

For example, when the TA is a cNode #2, the cNode #1 sends the request information #4 to the cNode #2.

After determining the TA, the cNode #1 directly sends the request information #4 to the TA.

It may be understood that the request information #4 sent in this step and the request information #4 sent in S1110 carry same content, and sending signaling is different.

S1160: The TCF #1 sends an acknowledgment message #4 to the UE via the cNode #1 and the sNode #1.

The TCF #1 sends the acknowledgment message #4 to the cNode #1, and the cNode #1 forwards the acknowledgment message #4 to the UE via the sNode #1.

For example, when the TA is the cNode #2, the cNode #2 sends the acknowledgment message #4 to the UE via the sNode #1 and the cNode #1.

The acknowledgment message #4 is used to acknowledge a task request to the UE.

It may be understood that the UE may send configuration information #1 to the TA by using the request information #4, or may send the configuration information #1 by using an independent message.

S1170: The UE sends the configuration information #1 to the TCF #1.

It may be understood that, after obtaining a type of the TA, the UE may directly send the configuration information #1 to the cNode #1 by using TRC signaling, and the cNode #1 sends the configuration information #1 to the TCF #1; or the UE may send the configuration information #1 to the TCF #1 by using T-NAS signaling.

For example, when the TA is the cNode #2, the UE sends the configuration information #1 to the sNode #1 by using the TRC signaling, the sNode #1 sends the configuration information #1 to the cNode #1, and the cNode #1 sends the configuration information #1 to the cNode #2.

S1180: The cNode #2 deploys the task.

The cNode #2 deploys the task on one or more TEs for execution based on the configuration information #1 and the task request.

For example, the TE may be a cNode connected to the TCF #1.

For example, if the TA is the cNode #2, the cNode #2 deploys the task. In this case, the TE may be an sNode connected to the cNode #2.

S1190: The TCF #1 sends a task result to the UE.

After executing the task, each executor reports an execution result to the TCF #1 for summarization, and then the TCF #1 sends a final task result to the UE via the cNode #1 and the sNode #1.

For example, if the TA is the cNode #2, the cNode #2 sends the task result to the UE.

In this technical solution, the UE sends the task request to a cNode in the access network, the cNode selects the TA based on the task request, the cNode directly forwards task messages such as the task request or a task configuration to the TA, and the TA completes task deployment. The cNode in the access network selects the TA, so that complexity of the UE can be reduced; and the UE senses the type of the TA, so that efficiency of subsequently sending a task message by the UE can be improved.

The following describes a solution of preconfiguring a task type and a TA type.

In a possible implementation, a mapping relationship between a task event and a TA type may be preconfigured for the UE.

Table 1 below is an example of the mapping relationship between the task event and the TA type.

TABLE 1

| Task event | Task anchor type |
|---|---|
| Task A/Type of the task A | RAN TA |
| Task B/Type of the task B | RAN TA |
| Task C/Type of the task C | CN TA |
| Task D/Type of the task D | CN TA |
| . . . | . . . |

In a possible implementation, a network configures the mapping relationship for the UE. The mapping relationship includes the correspondence between the task event and the TA type. The task event may be a task, or may be a task type.

For example, the network may configure the mapping relationship for the UE in the following manners.

Manner 1: A UE registration procedure includes initial registration, mobility registration update, and periodic registration update.

Manner 2: For a UE configuration update procedure, when the mapping relationship table changes, the TCF may trigger the UE configuration update procedure, and send a configuration update message to the UE, where the configuration update message carries a latest mapping relationship table. After performing local updating, the UE returns a configuration update acknowledgment to the TCF.

Manner 3: A paging procedure includes paging initiated by the access network or paging initiated by a core network.

In another possible implementation, the mapping relationship is predefined in a protocol, in other words, the correspondence between the task event and the TA type is predefined in the protocol.

The foregoing manners are merely examples for description, and do not constitute any limitation on this embodiment of this application.

Specifically, the UE determines, based on the mapping relationship, a TA type corresponding to the task #A, and the UE sends a task request to a node of the TA type.

For example, if the UE determines, based on the mapping relationship, that the TA type corresponding to the task #A is a core network element, the UE sends the task request to the TCF #1. The TCF #1 may deploy the task #A based on the task request, or may re-determine a TA based on the task request. For example, the method 1000 may be performed. In S1040, the TCF #1 may select a TA in the core network. Details are not described again.

For example, if the UE determines, based on the mapping relationship, that the TA type corresponding to the task #A is an access network element, the UE sends the task request to the cNode #1. The cNode #1 may deploy the task #A based on the task request, or may re-determine a TA based on the task request. For example, the method 900 may be performed. In S940, the cNode #1 may select a TA in the access network. Details are not described again.

In this technical solution, the UE may determine, based on the preconfigured mapping relationship between the task type and the TA type, a TA type corresponding to a to-be-initiated task, to directly send the task request to a TA of the type, thereby improving task access efficiency.

It should be understood that sequence numbers of the foregoing processes do not mean execution sequences. The execution sequence of the processes should be determined based on functions and internal logic of the processes, and should not be construed as any limitation on implementation processes of embodiments of this application.

The foregoing mainly describes the solutions provided in embodiments of this application from a perspective of interaction between network elements. It may be understood that, to implement the foregoing functions, each network element such as a transmit end device or a receive end device includes a corresponding hardware structure and/or software module for performing each function. A person skilled in the art should be able to be aware that, in this application, units and algorithm steps of the examples described with reference to embodiments disclosed in this specification can be implemented by hardware or a combination of hardware and computer software. Whether a function is performed by hardware or hardware driven by computer software depends on particular applications and design constraints of the technical solutions. A person skilled in the art may use different methods to implement the described functions for each particular application, but it should not be considered that the implementation exceeds the scope of this application.

In embodiments of this application, functional modules of a transmit end device or a receive end device may be obtained through division based on the foregoing method examples. For example, each functional module may be obtained through division based on each function, or two or more functions may be integrated into one processing module. The integrated module may be implemented in a form of hardware, or may be implemented in a form of a software functional module. It should be noted that, in embodiments of this application, module division is an example, and is merely a logical function division. In actual implementation, another division manner may be used. An example in which each functional module is obtained through division based on each corresponding function is used below for description.

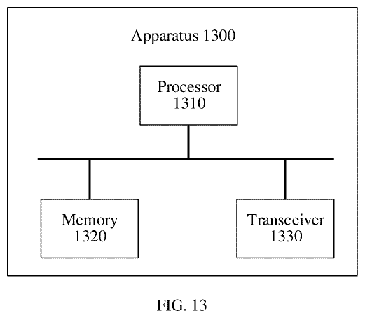

The methods provided in embodiments of this application are described above in detail with reference to FIG. 7 to FIG. 11. Apparatuses provided in embodiments of this application are described below in detail with reference to FIG. 12 and FIG. 13. It should be understood that descriptions of apparatus embodiments correspond to the descriptions of the method embodiments. Therefore, for content that is not described in detail, refer to the method embodiments. For brevity, details are not described herein.

FIG. 12 is a diagram of a communication apparatus 1200 according to an embodiment of this application.

The apparatus 1200 includes a transceiver unit 1210. The transceiver unit 1210 may be configured to implement a corresponding communication function. The transceiver unit 1210 may also be referred to as a communication interface or a communication unit.

The apparatus 1200 may further include a processing unit 1220, and the processing unit 1220 may be configured to process data.

Optionally, the apparatus 1200 further includes a storage unit. The storage unit may be configured to store instructions and/or data. The processing unit 1220 may read the instructions and/or the data in the storage unit, to enable the apparatus to implement actions of different devices in the foregoing method embodiments.

In a design, the apparatus 1200 is configured to perform actions performed by the first node in the foregoing method embodiments.

Specifically, the transceiver unit 1210 is configured to receive a first request from a terminal device, where the first request includes information about the first task. The processing unit 1220 is configured to determine a second node based on the first request, where the second node is configured to control execution of the first task. The transceiver unit 1210 is further configured to: send a type of the second node to the terminal device, where the type of the second node includes an access network element or a core network element; or send the first request to the second node, where the first request is used to request the second node to control execution of the first task.

In a design, the apparatus 1200 is configured to perform actions performed by the terminal device in the foregoing method embodiments.

Specifically, the processing unit 1220 is configured to obtain a first node, where the first node is configured to provide a management and control function for a first task, and the first task includes a process of implementing a service objective based on collaboration of heterogeneous resources; and the transceiver unit 1210 is configured to send a first request to the first node, where the first request includes information about the first task.

In a design, the apparatus 1200 is configured to perform actions performed by the third node in the foregoing method embodiments.

Specifically, the transceiver unit 1210 is configured to receive a first request from the terminal device, where the first request includes information about the first task requested by the terminal device, and the first task includes a process of implementing a service objective based on collaboration of heterogeneous resources; and the transceiver unit 1210 is further configured to send the first request to a second node, where the second node is determined based on an identifier that is of the second node and that is received from a first node, and the first node is configured to provide a management and control function for the first task; or the processing unit 1220 is configured to control execution of the first task based on the first request.

The apparatus 1200 may implement steps or procedures performed by the terminal device or the first node in the corresponding method embodiments based on embodiments of this application. The apparatus 1200 may include units configured to perform the methods performed by the terminal device or the network device (the TCF or the cNode) in the embodiments shown in FIG. 7, FIG. 8, FIG. 9, FIG. 10, and FIG. 11.

It should be understood that specific processes of performing the foregoing corresponding steps by the units are described in detail in the foregoing method embodiments. For brevity, details are not described herein again.

It should be understood that the apparatus 1200 herein is embodied in a form of a functional unit. The term “unit” herein may refer to an application-specific integrated circuit (application-specific integrated circuit, ASIC), an electronic circuit, a processor (for example, a shared processor, a dedicated processor, or a group processor) configured to execute one or more software or firmware programs, a memory, a merged logic circuit, and/or another appropriate component that supports the described function. In an optional example, a person skilled in the art may understand that the apparatus 1200 may be specifically the network device in the foregoing embodiments, and may be configured to perform each procedure and/or step corresponding to the network device in the foregoing method embodiments. To avoid repetition, details are not described herein again.

The apparatus 1200 in the foregoing solutions has a function of implementing a corresponding step performed by the device in the foregoing methods, or the apparatus 1200 in the foregoing solutions has a function of implementing a corresponding step performed by the network device in the foregoing methods. The function may be implemented by hardware, or may be implemented by executing corresponding software by hardware. The hardware or software includes one or more modules corresponding to the foregoing function. For example, a transceiver unit may be replaced with a transceiver (for example, a sending unit in the transceiver unit may be replaced with a transmitter, and a receiving unit in the transceiver unit may be replaced with a receiver), and another unit such as a processing unit may be replaced with a processor, to separately perform receiving and sending operations and a related processing operation in the method embodiments.

In addition, the transceiver unit 1210 may alternatively be a transceiver circuit (for example, the transceiver circuit may include a receiving circuit and a sending circuit), and the processing unit may be a processing circuit.

It should be noted that the apparatus in FIG. 1200 may be the network element or the device in the foregoing embodiments, or may be a chip or a chip system, for example, a system-on-chip (SoC). The transceiver unit may be an input/output circuit or a communication interface. The processing unit is a processor, a microprocessor, or an integrated circuit integrated on the chip. This is not limited herein.

FIG. 13 is a diagram of a communication apparatus 1300 according to an embodiment of this application. The apparatus 1300 includes a processor 1310. The processor 1310 is coupled to a memory 1320, the memory 1320 is configured to store a computer program or instructions and/or data, and the processor 1310 is configured to execute the computer program or the instructions stored in the memory 1320, or read the data stored in the memory 1320, to perform the method in the foregoing method embodiments. As shown in FIG. 13, the apparatus 1300 further includes a transceiver 1330. The transceiver 1330 is configured to receive and/or send a signal. For example, the processor 1310 is configured to control the transceiver 1330 to receive a signal and/or send a signal.

Optionally, there are one or more processors 1310.

Optionally, there are one or more memories 1320.

It should be understood that the processor 1310 and the memory 1320 may be combined into one processing apparatus. The processor 1310 is configured to execute program code stored in the memory 1320 to implement the foregoing functions. During specific implementation, the memory 1320 may alternatively be integrated into the processor 1310, or may be independent of the processor 1310. It should be understood that the processor 1310 may alternatively correspond to each processing unit in the foregoing communication apparatus, and the transceiver 1330 may correspond to each receiving unit and sending unit in the foregoing communication apparatus.

It should be further understood that the transceiver 1330 may include a receiver (or referred to as a receiver machine) and a transmitter (or referred to as a transmitter machine). The transceiver may further include an antenna, and there may be one or more antennas. The transceiver may alternatively be a communication interface or an interface circuit.

Specifically, the communication apparatus 1300 may correspond to the terminal device in the method 700 to the method 1100 based on embodiments of this application. The communication apparatus 1300 may include units of the methods performed by the network device in the method 700 to the method 1100. It should be understood that specific processes of performing the foregoing corresponding steps by the units are described in detail in the foregoing method embodiments. For brevity, details are not described herein again.

When the communication apparatus 1300 is a chip, the chip includes an interface unit and a processing unit. The interface unit may be an input/output circuit or a communication interface. The processing unit may be a processor, a microprocessor, or an integrated circuit integrated on the chip.

It should be understood that, the processor mentioned in embodiments of this application may be a central processing unit (CPU), or may be another general-purpose processor, a digital signal processor (DSP), an application specific integrated circuit (ASIC), a field programmable gate array (FPGA) or another programmable logic device, a discrete gate or a transistor logic device, a discrete hardware component, or the like. The general-purpose processor may be a microprocessor, or the processor may be any conventional processor or the like.

It should be further understood that the memory mentioned in embodiments of this application may be a volatile memory and/or a non-volatile memory. The nonvolatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM). For example, the RAM may be used as an external cache. By way of example, but not limitation, the RAM includes a plurality of forms, such as a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchlink dynamic random access memory (synchlink DRAM, SLDRAM), and a direct rambus random access memory (direct rambus RAM, DR RAM).

It should be noted that when the processor is a general-purpose processor, a DSP, an ASIC, an FPGA or another programmable logic device, a discrete gate or a transistor logic device, or a discrete hardware component, a memory (storage module) may be integrated into the processor.

It should further be noted that the memory described herein is intended to include, but is not limited to, these and any other appropriate type of memory.

This application further provides a computer-readable medium storing a computer program. When the computer program is executed by a computer, functions of any one of the foregoing method embodiments are implemented.

This application further provides a computer program product. When the computer program product is executed by a computer, functions of any one of the foregoing method embodiments are implemented.

This application further provides a system, including the first access network device, the second access network device, the access and mobility management function device, and the first session management function device.

All or some of the foregoing embodiments may be implemented by using software, hardware, firmware, or any combination thereof. When software is used to implement embodiments, all or a part of embodiments may be implemented in a form of a computer program product. The computer program product includes one or more computer instructions. When the computer instructions are loaded and executed on a computer, the procedures or functions based on embodiments of this application are all or partially generated. The computer may be a general-purpose computer, a dedicated computer, a computer network, or other programmable apparatuses. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by the computer, or a data storage device, for example, a server or a data center, integrating one or more usable media. The usable medium may be a magnetic medium (for example, a floppy disk, a hard disk drive, or a magnetic tape), an optical medium (for example, a high-density digital video disc (DVD)), a semiconductor medium (for example, a solid-state drive (SSD)), or the like.

In embodiments of this application, the term such as “example” or “for example” is for representing giving an example, an illustration, or a description. Any embodiment or design scheme described as an “example” in this application should not be explained as being more preferred or having more advantages than another embodiment or design scheme. Exactly, the term “example” is for presenting a concept in a specific manner.

It should be understood that, an “embodiment” mentioned throughout this specification means that particular features, structures, or characteristics related to this embodiment are included in at least one embodiment of this application. Therefore, embodiments in the entire specification do not necessarily refer to a same embodiment. In addition, these particular features, structures, or characteristics may be combined in one or more embodiments by using any appropriate manner.

It should be understood that sequence numbers of the foregoing processes do not mean execution sequences in various embodiments of this application. The execution sequence of the processes should be determined based on functions and internal logic of the processes, and should not be construed as any limitation on implementation processes of embodiments of this application. Names of all nodes and messages in this application are merely names set for ease of description in this application, and may be different in an actual network. It should not be understood that names of various nodes and messages are limited in this application. On the contrary, any name that has a function that is the same as or similar to that of the node or the message used in this application is considered as a method or an equivalent replacement in this application, and falls within the protection scope of this application.

It should be further understood that, in this application, “when” and “if” mean that the UE or the base station performs corresponding processing in an objective situation, are not intended to limit time, do not require the UE or the base station to necessarily perform a determining action during implementation, and do not mean another limitation.

It should be noted that, in embodiments of this application, “preset”, “preconfigure”, or the like may be implemented by pre-storing, in a device (for example, a terminal device), corresponding code, a table, or another manner that can indicate related information. A specific implementation thereof is not limited in this application, for example, a preset rule or a preset constant in embodiments of this application.

In addition, the terms “system” and “network” may be used interchangeably in this specification. The term “and/or” in this specification describes only an association relationship for describing associated objects and represents that three relationships may exist. For example, A and/or B may represent the following three cases: Only A exists, both A and B exist, and only B exists.

The term “at least one of . . . ” in this specification represents all or any combination of the listed items. For example, “at least one of A, B, and C” may represent the following six cases: A exists alone, B exists alone, C exists alone, A and B coexist, B and C coexist, and A, B, and C coexist. In this specification, “at least one” means one or more. “A plurality of” means two or more.

It should be understood that in embodiments of this application, “B corresponding to A” indicates that B is associated with A, and B may be determined based on A. However, it should be further understood that determining B based on A does not mean that B is determined based only on A. B may alternatively be determined based on A and/or other information. The terms “include”, “have”, and their variants all mean “include but are not limited to”, unless otherwise specifically emphasized in another manner.

It should be understood that, in various embodiments of this application, first, second, and various numbers are merely for differentiation for ease of description, and are not for limiting the scope of embodiments of this application. For example, different information is differentiated.

A person of ordinary skill in the art may be aware that, in combination with the examples described in embodiments disclosed in this specification, units and algorithm steps may be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation exceeds the scope of this application.

It may be clearly understood by a person skilled in the art that, for the purpose of convenient and brief description, for a detailed working process of the foregoing system, apparatus, and unit, refer to a corresponding process in the foregoing method embodiments. Details are not described herein again.

In the several embodiments provided in this application, it should be understood that the disclosed system, apparatus, and method may be implemented in other manners. For example, the described apparatus embodiments are merely examples. For example, division of the units is merely logical function division and may be other division during actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of embodiments.

In addition, functional units in embodiments of this application may be integrated into one processing unit, each of the units may exist alone physically, or two or more units may be integrated into one unit.

When the functions are implemented in the form of a software functional unit and sold or used as an independent product, the functions may be stored in a computer-readable storage medium. Based on such an understanding, the technical solutions of this application essentially, or the part contributing to a conventional technology, or some of the technical solutions may be implemented in the form of a software product. The computer software product is stored in a storage medium, and includes several instructions for indicating a computer device (which may be a personal computer, a server, or a network device) to perform all or a part of the steps of the methods described in embodiments of this application. The foregoing storage medium includes any medium that can store program code, such as a USB flash drive, a removable hard disk drive, a read-only memory (ROM), a random access memory (RAM), a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. A task-based communication method, applied to a first node, wherein the first node is configured to provide a management and control function for a first task, the first task comprises a process of implementing a service objective based on collaboration of heterogeneous resources, and the method comprises:
receiving a first request from a terminal device, wherein the first request is used to request to control execution of the first task, and the first request comprises information about the first task;
determining a second node based on the first request, wherein the second node is configured to control execution of the first task; and
sending a type of the second node to the terminal device, wherein the type of the second node comprises an access network element or a core network element; or
sending the first request to the second node.

2. The method according to claim 1, wherein before the first request is sent to the second node, the first request received from the terminal device is sent based on the type of the second node, the type of the second node is determined by the terminal device based on a first mapping relationship, and the first mapping relationship indicates a correspondence between an event of the first task and the type of the second node.

3. The method according to claim 2, wherein the method further comprises:
sending the first mapping relationship to the terminal device.

4. The method according to claim 1, wherein the first request further comprises first configuration information, and the first configuration information comprises a computing power configuration and/or an algorithm configuration for executing the first task.

5. The method according to claim 1, wherein the method further comprises:
receiving first configuration information from the terminal device; and
sending the first configuration information to the second node, wherein the first configuration information comprises a computing power configuration and/or an algorithm configuration for executing the first task.

6. The method according to claim 1, wherein the first node is a core network element or an access network element.

7. The method according to claim 1, wherein the method further comprises:
when the first node is the core network element, receiving the first request by using non-access stratum signaling; or
when the first node is the access network element, receiving the first request by using radio resource control signaling.

8. The method according to claim 1, wherein when the first node is the core network element, the method further comprises:
sending an identifier of the second node to a third node, wherein the third node is an access network element accessed by the terminal device.

9. The method according to claim 1, wherein the information about the first task comprises one or more of an identifier of the first task, an identifier of the terminal device, a type of the first task, a description of the first task, and a requirement of the first task.

10. A task-based communication method, applied to a terminal device, wherein the method comprises:
obtaining a first node, wherein the first node is configured to provide a management and control function for a first task, and the first task comprises a process of implementing a service objective based on collaboration of heterogeneous resources; and
sending a first request to the first node, wherein the first request is used to request to control execution of the first task, and the first request comprises information about the first task.

11. The method according to claim 10, wherein obtaining the first node comprises:
determining a type of a second node based on a first mapping relationship, wherein the first mapping relationship indicates a correspondence between an event of the first task and the type of the second node, and the type of the second node comprises a core network element or an access network element; and
determining the first node based on the type of the second node, wherein a type of the first node is the same as the type of the second node.

12. The method according to claim 11, wherein the method further comprises:
receiving the first mapping relationship from an access network element or a core network element.

13. The method according to claim 10, wherein the method further comprises:
receiving a type of a second node from the first node, wherein the type of the second node comprises a core network element or an access network element, and the second node is a node that is determined by the first node and that is configured to control execution of the first task; and
sending the first request to the second node based on the type of the second node, wherein the first request is used to request to control execution of the first task.

14. The method according to claim 10, wherein the first request further comprises first configuration information, and the first configuration information comprises a computing power configuration and/or an algorithm configuration for executing the first task.

15. The method according to claim 10, wherein the method further comprises:
sending first configuration information to the second node based on the type of the second node, wherein the first configuration information comprises a computing power configuration and/or an algorithm configuration for executing the first task.

16. The method according to claim 10, wherein the first node is a core network element or an access network element.

17. The method according to claim 10, wherein the method further comprises:
when the first node is the core network element, sending the first request by using non-access stratum signaling; or
when the first node is the access network element, sending the first request by using radio resource control signaling.

18. The method according to claim 10, wherein the information about the first task comprises one or more of an identifier of the first task, an identifier of the terminal device, a type of the first task, a description of the first task, and a requirement of the first task.

19. A communication apparatus, wherein the communication apparatus is configured to provide a management and control function for a first task, the first task comprises a process of implementing a service objective based on collaboration of heterogeneous resources, comprising:
at least one processor, wherein the processor is configured to determine a second node based on the first request, wherein the second node is configured to control execution of the first task;
a transceiver, wherein the transceiver is configured to receive a first request from a terminal device, wherein the first request is used to request to control execution of the first task, and the first request comprises information about the first task; and
send a type of the second node to the terminal device, wherein the type of the second node comprises an access network element or a core network element; or
send the first request to the second node.
